(19) United States
(12) Patent Application Publication
(10) Pub. No.: US 2021/0035196 A1
(43) Pub. Date: Feb. 4, 2021

(54) METHOD AND SYSTEM FOR IDENTIFYING, TRACKING, AND PREDICTING THE LOCATION OF MOVING MERCHANTS

(71) Applicant: Intuit Inc., Mountain View, CA (US)

(72) Inventors: Yehezkel S. Resheff, Tel Aviv (IL); Yair Horesh, Kfar-Saba (IL)

(73) Assignee: Intuit Inc., Mountain View, CA (US)

(21) Appl. No.: 16/524,521

(22) Filed: Jul. 29, 2019

(51) Int. Cl. G06Q 30/06; G06Q 30/02; G06Q 20/08

(52) U.S. Cl. CPC G06Q 30/0639; G06Q 20/085; G06Q 30/0205

(57) ABSTRACT

Customer transaction data is processed to determine transaction locations for transactions, including transactions whose locations are not initially known. The transaction location data is then utilized to identify merchants that are mobile merchants, and the mobile merchant locations are periodically recalculated and tracked. Customer transaction data is further utilized to identify relationships between mobile merchants and customers of those mobile merchants. Merchant and customer data is also analyzed to identify potential customers of mobile merchants, and data related to the mobile merchants is provided to current and potential customers of those mobile merchants.

### RELATED APPLICATIONS

The present application is related to previously filed U.S. patent application Ser. No. 16/012,918, entitled “PREDICTING LOCATIONS BASED ON TRANSACTION RECORDS,” filed in the name of Yehezkel S. Resheff et al., on Jun. 20, 2018, which is herein incorporated by reference in its entirety.

### BACKGROUND

Data management systems, such as transaction management systems, personal financial management systems, and small business management systems, have proven to be valuable and popular tools for helping individuals perform various tasks and manage their personal and professional lives. For a data management system to perform effectively and efficiently, the data management system should provide its users with analysis and support that is customized to the individual user. For instance, a data management system may provide a user with information about merchants that the user frequents. Providing this type of information can be of significant benefit to both the users/customers of the merchants and the merchants themselves.

In order to provide users with information regarding currently used merchants, or potential merchants, it is often necessary to determine the merchant's location, the merchant's hours of operation, and when the user is near the merchant. In many cases, determining where the merchant is located and the hours of operation is relatively simple. This is because many merchants operate at fixed physical locations, and at well-defined times at the fixed locations. However, more and more merchants are operating from variable, i.e., non-fixed, locations that, while still physical locations, vary according to time of day, day of the week, season etc. These mobile merchants are becoming more common in response to the ever-increasing mobility of customers and potential customers, and temporary or seasonal specialty markets.

As specific illustrative examples, many food service merchants now operate mobile trailers, trucks, and stands, that are stationed at locations, such as work sites, office/commercial settings, and special event locations that vary according to time of day, day of the week, etc. Likewise, many merchants cater to seasonal markets such as Halloween and other holidays, winter sports, etc. These merchants often take short term leases on fixed locations and operate from these locations, often the same location each year, but only for part of the year.

Because these mobile merchants are, by definition, not tied to fixed physical locations, ascertaining or predicting their location at any given time can be a very difficult task. This difficulty presents a problem for both customers of a mobile merchant, who want to know where and when they can find the merchant, and the merchant itself who potentially loses business when customers can't reach the merchant.

What is needed is a method and system to accurately determine, track and predict the locations of mobile merchants and then use this information to provide customers of the merchants with timely and relevant data related to the mobile merchants and mobile merchants' locations.

### SUMMARY

The disclosed embodiments provide a technical solution to the technical problem of accurately determining, tracking and predicting the locations of mobile merchants. This information is then used to provide customers of the merchants with timely and relevant data related to the mobile merchants and mobile merchants' locations so the customers can determine where a mobile merchant will be at a given time.

To this end, transaction data representing transactions between merchants and users of a data management system is processed to identify the locations of the transactions, and presumably the merchant payees associated with those transactions, at the time of the transactions. The transaction data is then further processed to identify merchant payees having transactions localized at different places on different days, or at different times of day. These merchants are then identified as mobile merchants. Once the mobile merchants are identified, the locations and schedules of the mobile merchants are determined. The locations and schedules of the mobile merchants are then made available to customers of the mobile merchants. In addition, customers of the mobile merchants who are also users of the data management system are further provided with mechanisms for receiving and requesting a variety of data related to the mobile merchants, such as location proximity alerts, offers, reviews, ratings, and predictions.

Consequently, the disclosed embodiments can be used to accurately determine, track and predict the locations of mobile merchants and provide customers of the merchants, who are also users of a data management system, with timely and relevant data related to the mobile merchants, including predictions as to where the mobile merchants will be at a given time.

### BRIEF DESCRIPTION OF THE DRAWINGS

FIG. 1 is a is a flow diagram of a process for identifying, tracking, and predicting locations of mobile merchants, in accordance with one embodiment.

FIG. 2 is a block diagram of a production environment for identifying, tracking, and predicting locations of mobile merchants, in accordance with one embodiment.

FIG. 3 is a flow diagram of a process for determining locations based on transaction data, in accordance with one embodiment.

FIG. 4A depicts an example determination of a predicted estimated location based on transaction data, in accordance with one embodiment.

FIG. 4B depicts an example determination of a predicted precise point location based on the predicted estimated location, in accordance with one embodiment.

FIG. 5 is a flow diagram of a process for identifying and tracking the location of mobile merchants, in accordance with one embodiment.

FIG. 6 is a specific illustrative example of a mobile merchants table, as utilized in accordance with one embodiment.

FIG. 7A and FIG. 7B are specific illustrative examples of predicted mobile merchants schedules, in accordance with one embodiment.

FIG. 8 is a flow diagram of a process for identifying relationships between mobile merchants and customers and then providing customers with mobile merchant data, in accordance with one embodiment.

FIG. 9A and FIG. 9B are specific illustrative examples of customer-merchant relationship tables, as utilized in accordance with one embodiment.

FIG. 10 is a flow diagram of a process for identifying potential customers of mobile merchants and providing potential customers with mobile merchant data, in accordance with one embodiment.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying figures, which depict one or more exemplary embodiments. Embodiments may be implemented in many different forms and should not be construed as limited to the embodiments set forth herein, shown in the figures, and/or described below. Rather, these exemplary embodiments are provided to allow a complete disclosure that conveys the principles of the invention, as set forth in the claims, to those of skill in the art.

In the disclosed embodiments, customer transaction data representing customer purchases from merchants is processed to determine where the purchases took place, and presumably where the merchant was at the time of the purchase transaction. The transaction locations are then utilized to identify merchants that are mobile merchants based on periodically changing locations being associated with purchase transactions for the same merchant. Updated locations for the identified mobile merchants are then periodically obtained and tracked. Customer transaction data representing customer purchases is then further utilized to identify relationships between mobile merchants and customers of those mobile merchants. Then information related to the mobile merchants, such as the merchants' current or predicted location at a given time, the current proximity of the merchants' customers to the merchants' predicted current location, offers from the merchants, and the like, is provided to current and potential customers of the mobile merchants.

Consequently, the disclosed embodiments can be used to accurately determine, track and predict the locations of mobile merchants and provide customers of the merchants with timely and relevant data related to the mobile merchants, including predictions as to where the mobile merchants will be at a given time.

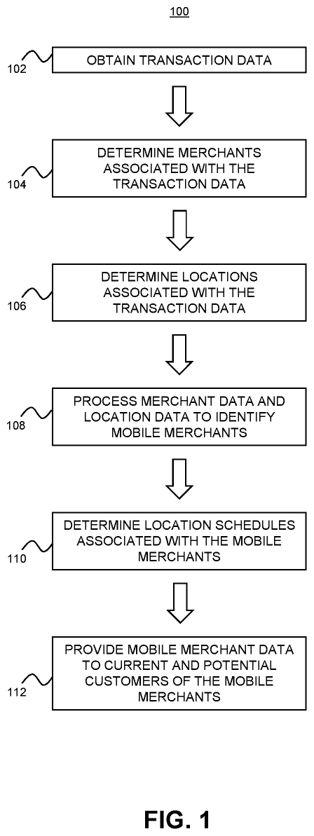

FIG. 1 illustrates a flow diagram of a process 100 for identifying mobile merchants, tracking the mobile merchant locations, and providing current and potential customers with data related to the mobile merchants. The process 100 as depicted in FIG. 1 provides an overview of the methods and systems disclosed herein, which will be discussed in further detail below.

At 102, transaction data representing one or more transactions between merchants and customers of those merchants is obtained. The transaction data may be obtained from a database associated with a data management system, or from a variety of third-party sources, such as, but not limited to, banks and other financial institutions.

At 104, the obtained transaction data is processed to determine the merchants that are associated with the transactions represented by the transaction data. The merchants may be determined by analyzing a merchant identification segment of the transaction data. In order to identify mobile merchants, locations associated with the merchants in general must first be determined.

At 106, the obtained transaction data is processed to determine transaction locations associated with the transactions represented by the transaction data. The transaction locations are further associated with the locations of the merchants. As discussed in more detail below, in the case where location data for a merchant is not present in records of transactions with that merchant, transaction data associated with merchants that have known locations may be utilized to generate a consumption graph, which enables the determination of location data for a merchant.

At 108, once locations of merchants are determined, the data representing the merchants and the transaction locations is further processed to identify merchants having user bases localized at different places on different days, or at different times of day. These merchants are then defined as mobile merchants, and data associated with these mobile merchants and their transaction histories is stored in a data structure for further use.

At 110, after the mobile merchant identification process is conducted, the list of mobile merchants is treated as static and newly available transaction data is utilized to continually update the mobile merchant data, such that accurate, timely, and relevant information regarding the locations and schedules of the mobile merchants can be made available to customers of the mobile merchants.

At 112, current and potential customers of the mobile merchants are provided with data regarding the locations and schedules of mobile merchants. In order to identify current and potential customers, the mobile merchants data is analyzed in conjunction with customer and transactional data. Customers of the mobile merchants who are also users of a data management system are further provided with mechanisms for receiving and requesting additional data related to the mobile merchants, such as location proximity alerts, offers, reviews, ratings, and predictions.

The process 100 described above and other features of the disclosed embodiments, discussed in more detail below, provide a method and system to accurately determine, track and predict the locations of mobile merchants and then use this information to provide customers of the merchants with timely and relevant data related to the mobile merchants and mobile merchants' locations.

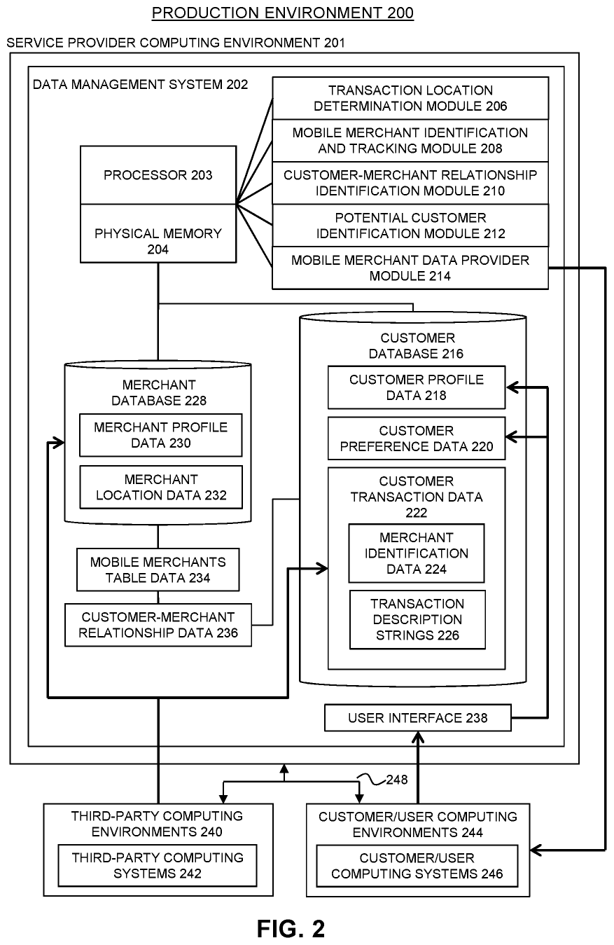

FIG. 2 illustrates a block diagram of a production environment 200 for identifying, tracking, and predicting mobile merchant locations, according to one embodiment. The production environment 200 includes service provider computing environment 201, third-party computing environments 240, and customer/user computing environments 244. Third-party computing environments 240 and customer/user computing environments 244 further comprise third-party computing systems 242 and customer/user computing systems 246, respectively. The computing environments 201, 240, and 244 are communicatively coupled to each other with one or more communication networks 248.

The service provider computing environment 201 includes a data management system 202 configured to provide data management services to users. Data management system 202 can be any data management system as discussed herein, known in the art at the time of filing, or as made available after the time of filing. As a specific illustrative examples, data management system 202 can be one or more of a personal financial transaction management system, a business financial transaction management system, a personal financial management system, a tax-preparation system, a business accounting system, a business inventory system, or any other system that collects, manages, processes, or otherwise manipulates transaction data associated with users of the data management system 202. The data management system 202 can include a system that manages one or more of book-keeping, accounting, banking, investments, loans, credit cards, real estate investments, retirement planning, bill pay, and budgeting.

The data management system 202 can be a standalone system that provides data management services to customers/users. Alternatively, the data management system 202 can be integrated into other software or service products provided by a service provider.

The data management system 202 includes processor 203 which, along with physical memory 204, coordinates the operation and interaction of the associated data and data processing modules. The data processing modules include transaction location determination module 206, mobile merchant identification and tracking module 208, customer-merchant relationship identification module 210, potential customer identification module 212, and mobile merchant data provider module 214.

The data utilized by the data processing modules 206, 208, 210, 212, and 214 includes the data stored in customer database 216, merchant database 228, mobile merchants table data 234, and customer-merchant relationship data 236. The data stored in customer database 216 includes customer profile data 218, customer preference data 220, and customer transaction data 222. The data stored in merchant database 228 includes merchant profile data 230, and merchant location data 232, which may be obtained from customer transaction data 222, and/or from a variety of third parties, such as those represented by third-party computing environments 240.

The users of data management system 202 may include customers of mobile merchants. The transaction location determination module 206 obtains data associated with customer transactions, for example, from customer transaction data 222, which may include customer transaction data previously obtained by data management system 202, and/or from third-party computing systems 242. Third-party computing systems 242 may include systems associated with financial institutions, for example. Customer transaction data 222 contains merchant identification data 224, transaction description strings 226, and may also include additional transaction data such as, but not limited to, transaction date, transaction time, transaction amount, transaction location, and a method of payment associated with a transaction. Merchant identification data 224 may include the name of a merchant, a merchant identification number, a branch identification string, a branch identification number, or any other type of data that may be used to identify a merchant.

As noted, in some cases, customer transaction data 222 includes transaction location data. In these cases, transaction location determination module 206 simply extracts this data to identify locations associated with customer transactions. However, in other cases, the transaction location data is not present. In these cases, other methods must be used to by transaction location determination module 206 to determine the location of the transactions, and presumably the locations of the merchant payees associated with those transactions.

As discussed in more detail below, one method used by transaction location determination module 206 in cases where the transaction location data is not present, is to utilize merchant identification data 224 to identify merchants associated with customer transactions and then analyze transaction description strings 226 to generate one or more branch identification patterns for each of the identified merchants. The branch identification patterns may include regular expressions, which comprise sequences of characters that define a specific search pattern.

In these cases where the transaction location data is not present, the transaction location determination module 206 then utilizes the branch identification patterns to determine whether branch identifiers exist in the transaction description strings 226. Upon a determination that branch identifiers exist, the branch identifiers are utilized to identify transactions that have been conducted at known locations, and the known location data is used to create one or more consumption graphs. The one or more consumption graphs are then utilized to determine estimated and/or precise point locations of transactions occurring at unknown locations, as will be discussed in further detail below. Estimated and/or precise point location data for transactions associated with a merchant, as well as previously known transaction location data associated with a merchant may be stored as part of merchant location data 232 of merchant database 228.

Once estimated and/or precise point locations of one or more transactions are determined, mobile merchant identification and tracking module 208 analyzes the customer transaction data 222 and the merchant location data 232 to identify merchants that are mobile merchants. Data related to merchants identified as mobile merchants is then stored as part of mobile merchants table data 234 for further analysis and processing, as will be discussed in further detail below. Mobile merchants table data 234 may include data such as, but not limited to, a merchant identification number, a merchant name, an estimated and/or precise point location associated with a mobile merchant on one or more days or at one or more times of day, as well as a count of the number of transactions that have been conducted with a particular merchant for any given period of time.

Once mobile merchants have been identified and tracked by mobile merchant identification and tracking module 208, customer-merchant relationship identification module 210 analyzes customer transaction data 222 in conjunction with mobile merchants table data 234 to identify relationships between customers and mobile merchants, a process which will be discussed in further detail below. The resulting customer-merchant relationship data 236 is then stored in a data structure for further processing and analysis. Customer-merchant relationship data 236 may include data such as, but not limited to, a customer name, customer ID, merchant name, merchant ID, a relationship type, as well as a number of transactions between a particular customer-merchant pair.

Once relationships between customers and mobile merchants are identified by customer-merchant relationship identification module 210, potential customer identification module 212 analyzes customer-merchant relationship data 236 in conjunction with customer profile data 218, customer preference data 220, customer transaction data 222, merchant profile data 230, merchant location data 232, and mobile merchants table data 234, to identify potential customers of mobile merchants. The process utilized by potential customer identification module 212 to identify potential customers of mobile merchants will be discussed in further detail below.

Customer profile data 218 includes data such as, but not limited to, data associated with a customer's geographical location, age, race, gender, marital status, financial status, educational status, career status, number and type of dependents, and/or any other customer data that may be known about a customer. Customer preference data 220 includes data associated with customer preferences, such as, but not limited to, the types of goods and/or services a customer is interested in, one or more preferred geographical locations, preferred merchant features or amenities, a preferred merchant rating, a preferred price point associated with a merchant, and/or data regarding the frequency with which a customer may wish to receive data regarding mobile merchants. Merchant profile data 230 includes data such as, but not limited to, the types of goods and/or services provided by a merchant, features or amenities provided by a merchant, a merchant rating and/or a price point associated with a merchant. Once potential customer identification module 212 has identified potential customers of mobile merchants, customer-merchant relationship data 236 is updated to indicate any newly identified relationships between customers and mobile merchants.

Mobile merchant data provider module 214 processes and analyzes the customer-merchant relationship data 236 in conjunction with customer profile data 218, customer preference data 220, and any other data that may be dynamically provided by a customer, for instance, through user interface 238 of data management system 202. User interface 238 enables customer/user computing systems 246 to interact with aspects of the method and system disclosed herein. For example, a customer may interact with user interface 238 to provide data to data management system 202, such as customer profile data 218 and customer preference data 220.

Processing of the customer-merchant relationship data 236, customer profile data 218, and customer preference data 220 is performed prior to providing mobile merchant data to customers in order to determine whether to send mobile merchant data to a particular customer, and if so, to determine what specific data should be sent, taking into account any known customer preferences. Upon a determination that mobile merchant data should be provided to one or more customers, the mobile merchant data provider module 214 proceeds with providing the mobile merchant data.

Mobile merchant data may be provided to customers by mobile merchant data provider module 214 through a variety of mechanisms, such as, but not limited to, sending a Short Media Service (SMS) message, sending a Multimedia Messaging Service (MMS) message, sending a message though an instant messaging service, sending an email, initiating a phone call, and/or providing data to a customer online through a social media platform. The mobile merchant data may also be provided to customers through user interface 238 of data management system 202.

Further, mobile merchant data provided to customers by mobile merchant data provider module 214 may include data such as, but not limited to, current, predictive, and/or historical location data associated with mobile merchants, ratings and reviews associated with mobile merchants, a listing of products or services provided by mobile merchants, prices associated with the products or services provided by mobile merchants, images related to mobile merchants and their products or services, links to websites or pages on social media platforms associated with mobile merchants, data regarding expected wait times at mobile merchants, data relating to offers such as coupons, or data regarding events or sales associated with mobile merchants.

The mobile merchant data provided to customers by mobile merchant data provider module 214 may include data associated with mobile merchants that customers frequently conduct transactions with, mobile merchants being recommended to customers, as well as mobile merchants that customers have otherwise indicated an interest in, for example, through user interface 238 of data management system 202.

In the disclosed embodiments, as noted, in some cases, customer transaction data 222 includes transaction location data. In these cases, transaction location determination module 206 simply extracts this data to identify locations associated with customer transactions, and presumably the locations of the merchant payees. However, in other cases, the transaction location data is not present.

When the location of a given transaction is not known, one or more methods and systems can be used to determine an estimated and/or precise point location associated with the transaction based on analysis of the transaction data. Specific illustrative examples of methods and systems for using transaction data to determine an estimated and/or precise point location associated with the transaction are disclosed in previously filed U.S. patent application Ser. No. 16/012,918, entitled “PREDICTING LOCATIONS BASED ON TRANSACTION RECORDS,” filed in the name of Yehezkel S. Resheff et al., on June 20, 2018, which is herein incorporated by reference in its entirety.

In order to utilize transaction records without location data, the transaction data associated with one or more merchants with known locations can be used to determine an estimated location associated with a transaction record that does not include location data. For example, the estimated location can be determined based on shared customers between one or more merchants with known locations and a merchant with an unknown location. Based on the determined estimated location, a precise point location can also be determined for transactions associated with a merchant with an unknown location. For example, a query can be made to a location service application programming interface (API) with the estimated location and the merchant as input to generate an output of a precise point location.

The underlying assumption for determining locations based on transaction data is that customers tend to make regular purchases in a localized area. For example, a customer may make purchases at a grocery store, coffee shop, and gas station all relatively proximate to each other. The grocery store, coffee shop, and gas station are assumed to be in a localized area and close to each other in terms of both time and distance. This is so because it would not make sense for a customer to travel far away (e.g., outside of a localized area) in terms of time and distance to make regular purchases at each location.

In addition to practical applications associated with determining locations based on transaction data, a single instance of determining location data allows for the location data to be used in a number of different applications, thereby allowing the reuse of the location data rather than re-generating the location data.

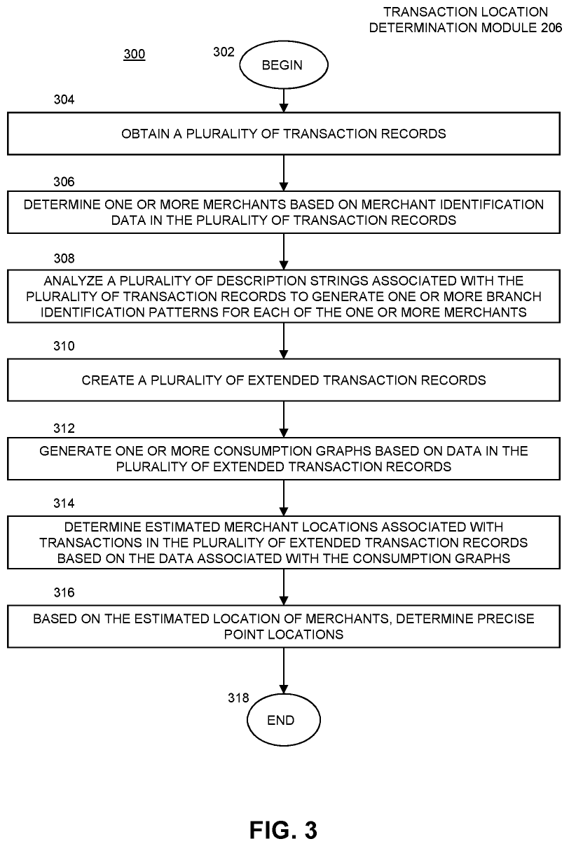

FIG. 3 illustrates a flow diagram of a process 300 for determining transaction locations based on transaction data when the transaction location data is not present.

Process 300 begins at 302 and process flow proceeds to 304. At 304, a first set of transaction records associated with a first time period is obtained. Transaction data in the first set of transaction records comprises data such as, but not limited to, a customer identification, a merchant identification, and a description string. Customer identification includes a user name and account number. Merchant identification includes a merchant name and account number. A description string includes city information, street address, branch identifier, transaction time, transaction date, and transaction amount. The transaction data is stored in a data structure, such as a tabular record. For example, the transaction data may be stored in vectors, database rows, and XML files. The transaction data may be collected from third party institutions, such as, but not limited to, banks, credit card companies, and insurance companies.

Once the first set of transaction records is obtained at 304, process flow proceeds to 306. At 306, one or more merchants are determined based on merchant identification data present in the first set of transaction records.

For example, a merchant may be determined based on data stored in a merchant identification segment of the transaction record. Merchants may include, for example, retailers, wholesalers, and service providers. The data stored in the merchant identification segment includes identification data, such as, but not limited to, a name or a number that is used to identify the merchant associated with the transaction. The data in the merchant identification segment may also include a branch identifier, however the branch identifiers are more typically included as part of the transaction description string.

A branch identifier may comprise, for example, a store identification number, or any other alphanumeric string that can be used to identify a unique merchant. For example, in the case where more than one merchant exists with the same name, a branch identifier would enable one merchant to be differentiated from another. The branch identifiers may be included in any part of a transaction description string and rarely comply with any one standard format.

Once one or more merchants are determined at 306, process flow proceeds to 308. At 308, a plurality of description strings associated with the first set of transaction records is analyzed to generate one or more branch identification patterns for each of the one or more merchants.

The one or more branch identification patterns may include regular expressions, which comprise sequences of characters that define a specific search pattern. For example, a branch identification pattern may comprise a sequence of characters for identifying specific branch identifiers in the description strings associated with the first set of transaction records. A branch identification pattern may be generated either manually or automatically, based on the transaction data associated with a merchant.

Once one or more branch identification patterns are generated at 308, process flow proceeds to 310. At 310 a first set of extended transaction records is created by appending branch identifiers to the transaction records associated with the previously determined merchants. The branch identifiers are determined using the previously generated branch identification patterns, by applying one or more of the branch identification patterns to the data in the one or more transaction records in the first set of transaction records. The application of the branch identification pattern may determine that transactions in the first set of transaction records are associated with a particular branch of a particular merchant

When the branch identifier is a store identification number, a location can typically be determined based on the store identification number. For example, if the store identification number is determined as 1234, then third party resources, such as third party databases, can be queried to determine the location associated with the transaction. Continuing the example, a third party database may provide corresponding location data based on the store identification number. Upon determining the corresponding location data, transaction data associated with a merchant that includes the store identification number is appended to the data in the first set of transaction records to create a first set of extended transaction records. Furthermore, the extended transaction record data associated with branch identifiers that have known locations will be used to define known location nodes. Location nodes are utilized in the generation of consumption graphs, as will be discussed in further detail below.

In some situations, a branch identifier may be determined using the branch identification pattern, but the branch identifier may be an identifier other than a store identification number, and/or corresponding location data may not be available from third party databases. Upon determining there is no corresponding location data associated with a branch identifier, the extended transaction record data associated with that branch identifier will be used to define unknown location nodes.

Further, it may be the case that no branch identifiers are determined after applying branch identification patterns. When no branch identifiers can be determined, the associated transaction record data may be discarded from consideration. Discarding the data in the transaction records with no branch identifiers will reduce the overall number of transaction records to be analyzed, which in turn will cause the process of determining locations based on transaction data to be faster and more accurate.

Once a first set of extended transaction records is created at 310, process flow proceeds to 312. At 312 one or more consumption graphs are generated based on the data in the first set of extended transaction records. A consumption graph includes nodes connected by edges. Each node in a consumption graph is associated with a particular merchant and a particular branch of that merchant. The nodes are defined by the data in the extended transaction records associated with the same merchant identification and the same branch identifier. For example, each node in a consumption graph can be defined by specific merchant identification data and specific branch identification data. Furthermore, each node in a consumption graph may also be defined as a known location node or an unknown location node, depending on whether the location of the specific merchant and specific branch is known.

Though not depicted in FIG. 3, a total number of customers associated with each node may be determined. For example, the total number of customers associated with a node may be determined based on the data in the associated extended transaction records. Continuing the example, the extended transaction record data associated with customers that have only one transaction at a particular node is discarded. This extended transaction record data is discarded based on the assumption that a customer makes regular transactions in a localized area. A single transaction for a customer at a particular location of a merchant would not be consistent with determining location based on shared user behavior and would instead be indicative of anomalous behavior.

Each edge of the consumption graph may be defined as a relationship between each unique pair of nodes. For example, a defined relationship can be based on a percentage of shared customers, i.e., customers that have transactions associated with each node in a unique pair of nodes. A unique pair of nodes may comprise a first location node and a second location node. For example, the first location node may be a known location node and the second location node may be an unknown location node. Thus, the total number of unique customers having transactions associated with either the known location node or the unknown location node in a unique pair of nodes may first be determined. The percentage of shared customers may then be defined as the percentage of the total number of unique customers having transactions associated with both nodes in the unique pair of nodes.

Once one or more consumption graphs are generated at 312, process flow proceeds to 314. At 314, estimated merchant locations associated with transactions in the first set of extended transaction records are determined based on the consumption graphs.

Estimated merchant location data associated with an unknown location node is determined based on the known location nodes in one or more of the consumption graphs. The number of known location nodes used for determining estimated merchant location data associated with an unknown location node is based on the percentage of shared customers between each known location node and the unknown location node. The percentage of shared customers may indicate substantial customer sharing between the two nodes. Additionally, the number of known location nodes used for determining the estimated merchant location data associated with an unknown location node is dynamic.

For example, the shared customer percentages may be low between each known location node and an unknown location node, so a greater number of known location nodes may be needed in determining the estimated merchant location data associated with the unknown location node. For example, if there are four known location nodes, each with a shared customer percentage of 3%, 3.5%, 2%, and 1.8% respectively with the unknown location node, then additional known location nodes may be included in the determination of the estimated merchant location data associated with the unknown location node.

Continuing the example, the shared customer percentages may be high between each known location node and an unknown location node, so a fewer number of known location nodes may be needed to determine the estimated merchant location data associated with the unknown location node. For example, if there are three known location nodes, each with a shared customer percentage of 35%, 40%, and 42%, respectively with the unknown location node, then no more additional known location nodes will be needed in the determination of the estimated merchant location data associated with the unknown location node.

After determining the number of known location nodes needed based on the shared customer percentages, the estimated merchant location data associated with an unknown location node is determined. The estimated location data may be based on Universal Transverse Mercator (UTM) grid coordinates associated with each of the known location nodes and the edge connecting each known location node and unknown location node.

An edge connecting a pair of location nodes may comprise a weighted value based on a percentage of total unique customers that have transactions associated with both location nodes in the pair of location nodes. The weighted value may also be based on a time and/or distance factor. For example, there may be five location nodes. Of the five location nodes, there are four known location nodes and one unknown location node. A weight value for each edge is determined based on the percentage of shared customers between each known location node and the unknown location node.

Continuing the example, based on the data in the extended transaction records, it may be determined that the first known location node and the unknown location node has 35% shared customers, the second known location node and the unknown location node has 25% shared customers, the third known location node and the unknown location node has 10% shared customers, and the fourth known location node and the unknown location node has 30% shared customers.

Based on the percentages of shared customers, the weight values defining the relationship between the first known location node and the unknown location node is 35%, the second known location node and the unknown location node is 25%, the third known location node and the unknown location node is 10%, and the fourth known location node and the unknown location node is 30%. The shared percentages may or may not also be normalized so that the total weight coefficient value equals 1.

An edge connecting a pair of location nodes may also comprise an equal weighted value based on the number of known location nodes. For example, there may be five location nodes. Of the five locations nodes, there are four known location nodes and one unknown location. An equal percentage of shared customers is assumed between each known location node and the unknown location. A total weight value of 1 is divided by the total number of known location nodes, which in this example is four known location nodes. The equal weight value of 25% is determined for defining the relationship between each known location node and the unknown location node.

The weight of an edge connecting a pair of location nodes may be further adjusted or based on a time factor. An edge weight may be given a greater weight value if, for example, it is determined that the shared transactions took place during afternoon rush hour on a weekday. In comparison, an edge weight may be given a lesser edge weight value if, for example, it is determined that the shared transactions took place at 2 am on a weekday.

The Universal Transverse Mercator (UTM) grid coordinate system may be used when determining estimated location data. The UTM grid coordinate system is particularly convenient for determining the estimated location data because it is easy to perform mathematical operations based on UTM grid coordinates. The estimated location is determined based on the UTM grid coordinates of the known location nodes and the weight values of the edges between nodes. By applying weighting factors from the edges between nodes to locations of known nodes, an estimated location may be generated as UTM grid coordinates for an unknown location node.

An edge may also be defined by a statistical model of customer sharing based on distance. For example, the statistical model may indicate a certain percentage or percentage range of shared customers given a certain distance between two known location nodes. Continuing the example, if the distance between two known location nodes is 1 mile, then the statistical model may indicate the shared percentage of customers is between 15% and 18%. If the distance between two known location nodes is 2 miles, the statistical model may indicate the shared percentage of customers is between 10% and 13%.

Using the statistical model, a distance between a known location node and an unknown location node may be determined based on the shared percentage of customers. For example, if there are 12% of shared customers between the known location node and the unknown location node, using the statistical model, it can be determined that the distance between the known location node and the unknown location node is 2 miles.

The estimated location data determined for each unknown location node may also be associated with a dynamic percentage of error. For example, if few known location nodes were used to determine the estimated location data of the unknown location node, the percentage of error may be higher in comparison to the case where more known location nodes were used to determine the estimated location data.

Further, more than one estimated location may be determined based on the data in the first set of transaction records. For example, the statistical model may determine the distance between a known location node and an unknown location node to be 2 miles. However, the 2 mile distance between the known location node and the unknown location node may result in the estimated location being mapped to two different, yet neighboring, zip codes. Other examples of estimated locations include cities, states, and landmarks.

In cases where more than one estimated location is determined, a second set of transaction records associated with a second time period may be obtained. The data in the second set of transaction records can be combined with the data in the first set of transaction records. Continuing the example, the second set of transaction records can be used to narrow the determination of the estimated location based on additional shared customer data, additional known location nodes for determining estimated locations, or other additional data associated with the second set of transaction records.

Obtaining additional sets of transaction records can continue until a specific threshold is reached. For example, the threshold may include retrieving up to a certain number of sets of transaction records and retrieving transaction records from a certain time period. If upon reaching the threshold there is still more than one estimated location determined for an unknown location node, then the data in the transaction record associated with the unknown location node can be discarded.

Further, it may be the case that no estimated location is determined based on the data in the first set of transaction records. If no estimated location is determined, then a second set of transaction records associated with a second time period may be obtained. This may continue until a specific threshold is reached, and if still no estimated location can be determined, then the data in the transaction record associated with the unknown location node can be discarded.

Initially obtaining a first set of transaction records, and then only obtaining additional sets of transaction records as needed, prevents expending more computing resources and processing time than necessary for determining merchant locations based on transaction data.

Once estimated locations of merchants are determined at 314, process flow proceeds to 316. At 316, precise point locations of merchants are determined based on the estimated merchant locations.

For example, based on the UTM grid coordinates of an estimated location, a location service API may be queried with the associated merchant identification information and the estimated location information to determine the precise point location. For example, a query may be formed with a certain language construct such as “[merchant name] near [estimated UTM grid coordinates]” and a location service API may return one or more exact locations of merchants near those grid coordinates. In some cases, the closest returned merchant location may be selected as the precise point location.

In order to save computation time and scale the process of determining locations based on transaction data, a location service API can be queried with rough estimate location information. Continuing the example, rough estimate location information can be a query input with the merchant identification to the location service API to determine a precise point location of an unknown location node. Rough estimate location information includes a zip code, neighborhood, city, state, and landmark. For example, a query may be formed with a certain language construct such as “[merchant name] near [zip code]” and a location service API may return one or more exact locations of merchants near or within the zip code. In some cases, the closest returned merchant location may be selected as the precise point location.

Using a rough estimate location such as zip code and the merchant identification of a merchant associated with an unknown location node, a precise point location of the unknown location node can be determined without having to consume additional resources to compute UTM grid coordinates of the estimated location. In some cases, using the rough estimate location data and the merchant identification data may fail to provide a single precise point location, and a more accurate estimated location may need to be determined first, such as UTM grid coordinates.

Once a precise point location of a merchant is determined at 316, process flow proceeds to END 318, and the process 300 for determining transaction locations based on transaction data is exited to await new data and/or instructions.

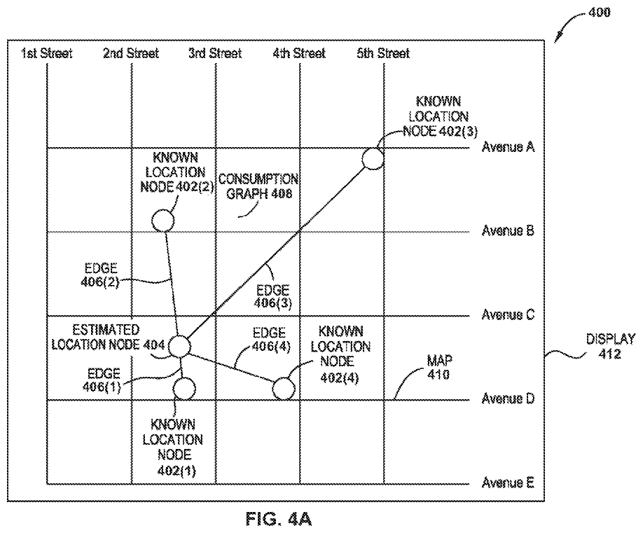

In cases where the transaction location data is not present, the system and method disclosed herein may further comprise overlaying a consumption graph on a map, for example on a display of an electronic device, such as depicted in the illustrative examples of FIG. 4A and FIG. 4B. One reason for overlaying a consumption graph on a map on a device display is to allow a customer, who may be a user of the system and method disclosed herein, to confirm the determined estimated and/or precise point location associated with a merchant.

FIG. 4A depicts an example determination 400 of estimated merchant location data based on transaction record data, as shown on a display of a computing device. In the example determination 400, the following nodes have been determined: a first known location node 402(1), a second known location node 402(2), a third known location node 402(3), and a fourth known location node 402(4). Additionally, an estimated location is determined for an unknown location node, represented here by estimated location node 404. The location of estimated location node 404 is based on the known location nodes 402 and connecting edges 406.

As discussed above, the number of known location nodes used to determine estimated merchant location data associated with an unknown location node may vary depending on the percentage of shared customers between each known location node and the unknown location node. For example, in urban areas where there are a high number of merchants, there may be a low percentage of shared customers between each known location node and the unknown location node (e.g., because customers have more choices), so the number of known location nodes used to determine estimated merchant location data associated with an unknown location node may be greater. In comparison, in rural areas where there are a few number of merchants, there may be a high percentage of shared customers between each known location node and the unknown location node (e.g., because customers have fewer choices), so the number of known location nodes used to determine estimated merchant location data associated with an unknown location node may be fewer relative to the number of known location nodes in urban areas.

As depicted in FIG. 4A, each known location node 402(1), 402(2), 402(3), and 402(4) is connected to estimated location node 404 by edges 406(1), 406(2), 406(3) and 406(4), respectively. The edges 406 are defined between each pairing of estimated location node 404 and the known location nodes 402(1), 402(2), 402(3), and 402(4). Prior to determination of the estimated location of estimated location node 404, estimated location node 404 is defined as the unknown location node.

The weights of the edges 406(1), 406(2), 406(3) and 406(4) connecting each known location node and the unknown location node may be defined based on a percentage of customers that have transactions associated with both the unknown location node and the respective known location nodes 402(1), 402(2), 402(3), and 402(4).

For example, the weight of edge 406(1) connecting the unknown location node and the first known location node 402(1) may be defined as 35% shared customers. The weight of edge 406(2) connecting the unknown location node and the second known location node 402(2) may be defined as 25% shared customers, the weight of edge 406(3) connecting the unknown location node and the third known location node 402(3) may be defined as 10% shared customers, and the weight of edge 406(4) connecting the unknown location node and the fourth known location node 402(4) may be defined as 30% shared customers.

Estimated merchant location data associated with the unknown location node is determined based on the weight values associated with each edge 406 and the UTM grid coordinates of the known location nodes 402, resulting in the transformation of the unknown location node into estimated location node 404.

As depicted on the display 412, the first known location node 402(1) has an address of 250 Avenue D. The second known location node 402(2) has an address of 200 Avenue B. The third known location node 402(3) has an address of 100 5^{th} Street. The fourth known location node 402(4) has an address of 370 Avenue D.

The estimated merchant location associated with the unknown location node may be determined based on the UTM grid coordinates of each known location node 402 and the weight value of each edge 406 connecting each known location node 402 and the unknown location node. For example, the UTM grid coordinates of each known location node 402 may be determined based on the street address information. In some examples, a third party service may be queried, for example, through a location service API, to convert the street addresses to UTM grid coordinates. Continuing the example, the UTM grid coordinates of the unknown location node may then be determined based on the UTM grid coordinates of each known location node 402 and the weight value associated with the connecting edges 406, resulting in the estimated location node 404 on the consumption graph 408.

Additionally, the resulting UTM grid coordinates of the estimated location node 404 may be indicative of the estimated location information within a margin of error. The margin of error varies depending on the number of known location nodes 402 used to calculate the location of estimated location node 404 for an unknown location node.

The estimated location may also be calculated based on equal edge weights. For example, the weight of edge 406(1) connecting the unknown location node and the first known location node 402(1) may be defined as 25%. The weight of edge 406(2) connecting the unknown location node and the second known location node 402(2) may be defined as 25%, the weight of edge 406(3) connecting the unknown location node and the third known location node 402(3) may be defined as 25%, and the weight of edge 406(4) connecting the unknown location node and the fourth known location node 402(4) may be defined as 25%. Each edge has a weight value of 25%, and the total weight value of the edges is equal to 1.

Based on the UTM grid coordinates for each known location node 402 and the weight value for the edges 406 connecting each known location node 402 to the unknown location node, the resulting UTM grid coordinates may indicate the estimated location for the estimated location node 404 within a certain margin of error.

Further, the location of estimated location node 404 may be confirmed by a customer, who may also be a user of the system and method disclosed herein. For example, upon determining estimated location data, the consumption graph 408 with the known location nodes 402 and the estimated location node 404 can be overlaid on a map 410. The display 412 will display both consumption graph 408 and map 410. If the placement of the known location nodes 402 on the map 410 is consistent with the known location data associated with the respective known location nodes, then the placement of the estimated location node 404 may confirm the associated estimated location information. Additionally, the user may be prompted to confirm the estimated location data associated with estimated location node 404 based on the consumption graph 408 and displayed map 410. The user may determine, based on reviewing the placement of consumption graph nodes on the map 410, whether the estimated location data is accurate.

FIG. 4B depicts an example determination 450 of a precise point location based on the estimated location on a display of a computing device. The estimated location determined can comprise a UTM grid coordinate, zip code, neighborhood, landmark, city, and state. The estimated location information can be used to query a location service API. The location service API can be queried with the merchant identification upon determining a rough estimate of the location associated with the unknown location node such as zip code, neighborhood, city, state, and landmark. Querying the location service API with a rough estimate would reduce computation power and resources consumed to determine an estimated location such as UTM coordinates based on shared customers. In other embodiments, the location service API can be queried with a merchant identification and determined UTM coordinates.

After determining the precise point location of the estimated location node, the precise point location can be displayed on the display 412 of a computing device as the precise location node 414. Additionally, the precise point location data associated with the precise location node 414 can be appended to the data in the transaction records and the node can be classified as a known location node for subsequent determinations of locations based on transaction data.

Additionally, when the precise point location is displayed on the display 412, users can provide feedback via the display 412. For example, if the precise point location of the precise location node 414 for associated extended transaction records is found to be inaccurate, for example, based on the estimated location information, then the user may indicate this inaccuracy via the display 412 of the computing device as well as provide corrections. The feedback provided by the user can recalibrate the determination of the estimated and precise point locations for subsequent determinations of locations based on transaction data.

In the discussion above, when the transaction location data is not present, an estimated and/or precise point location associated with merchant transactions is determined using the methods of previously filed U.S. patent application Ser. No. 16/012,918, entitled “PREDICTING LOCATIONS BASED ON TRANSACTION RECORDS,” filed in the name of Yehezkel S. Resheff et al., on Jun. 20, 2018. However, as noted above, this is but one specific example of methods for determining estimated and/or precise point location associated with merchant transactions when the transaction location data is not present. In other examples, any methods or systems for determining an estimated and/or precise location associated with merchant transactions when the transaction location data is not present, as discussed herein, or known in the art at the time of filing, or as become known after the time of filing, can be utilized.

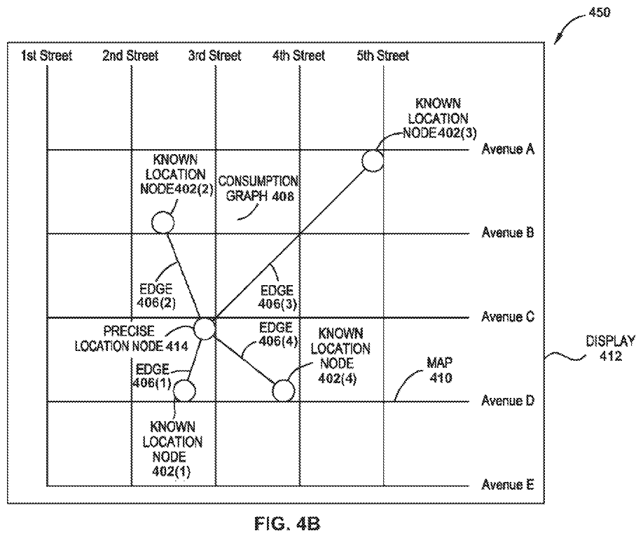

In accordance with the disclosed embodiments, once the transaction location data, if present, is identified, or estimated and/or precise locations associated with merchant transactions are determined using a location determination process, such as process 300 discussed above, the location data is then used to identify and track the locations of merchants who are mobile merchants. FIG. 5 illustrates a flow diagram of a process 500 for identifying and tracking the location of mobile merchants.

Referring now to FIG. 5 and FIG. 3 together, process 500 begins at 502 and process flow proceeds to 504. At 504 data representing the estimated and/or precise point locations of merchants that are associated with a set of transaction records is obtained, either from location data included in the transaction data, if present, or using the process set forth above with respect to FIG. 3.

Once estimated and/or precise point locations of merchants are obtained at 504, process flow proceeds to 506. At 506, the obtained location data associated with one or more merchants is processed in order to identify merchants that are mobile merchants.

Mobile merchants are identified by processing the estimated and/or precise point locations associated with the one or more merchants, however this information is obtained, to determine whether transactions with individual merchants occurred at different locations on different days or at different locations at different times of day. For example, transaction data may indicate that hundreds of transactions occurred with a specific merchant during a certain period of time. Of these hundreds of transactions, the estimated and/or precise point location data associated with each individual transaction may indicate that some of the transactions occurred at a first address on a first day of the week, while some of the transactions occurred at a second address on a second day of the week. In addition, the estimated and/or precise point location data associated with each individual transaction may further indicate that some of the transactions occurred at a first address at a first time of day, while some of the transactions occurred at a second address at a second time of day. Upon a determination that transactions with a given merchant routinely occur at different locations on different days or at different times of day, the merchant is identified as a mobile merchant.

It should be noted that a threshold number of transactions associated with a merchant occurring at different locations, as well as a threshold number of different locations associated with the merchant, may be set in order to provide definition for the term “routinely.” The threshold number of transactions and the threshold number of locations may be analyzed over a particular period of time in order to more accurately identify mobile merchants. For example, if a merchant conducts a small number of transactions at a first location, during a short period of time, and thereafter conducts a large number of transactions at a second location over a long period of time, without ever moving to a third location, then the merchant may not be identified as a mobile merchant.

The mobile merchant identification process described above may be conducted once, and thereafter the list of identified mobile merchants is treated as static. The mobile merchant identification process may also be conducted periodically in order to identify mobile merchants that are newly established mobile merchants, or to remove records of merchants that are no longer operational.

Once one or more mobile merchants are identified at 506, process flow proceeds to 508. At 508, data associated with the merchants that have been identified as mobile merchants is formatted into one or more tables, resulting in the generation of one or more mobile merchants tables.

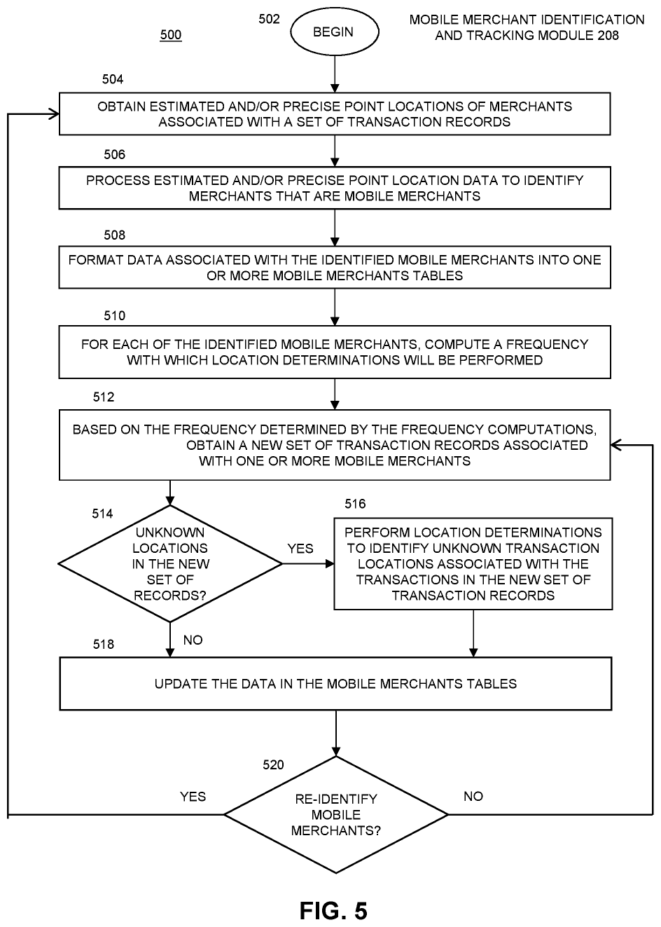

FIG. 6 is an illustrative example of a mobile merchants table 600, in accordance with one embodiment. In this specific illustrative example, the mobile merchants table 600 comprises one row for each merchant-location pair associated with a particular contiguous period of time. The merchant-location rows are shown here in FIG. 6 as merchant-location rows 602, 604, 606, 608, 610, 612, 614, 616, 618, and 620. In the example depicted in FIG. 6, the mobile merchants table 600 may further include one column each for various details associated with each merchant-location pair over a particular contiguous period of time. For example, according to the embodiment illustrated in FIG. 6, the mobile merchants table 600 contains a merchant ID column 622, a merchant name column 624, and a transaction location column 626. The mobile merchants table 600 further contains a first transaction date column 628, a last transaction date column 630, and a number of transactions column 632, which contains the number of transactions associated with a merchant-location pair during the contiguous period of time between a first transaction date and a last transaction date.

For instance, in the specific illustrative example of FIG. 6, the date in the first transaction date column 628 and the date in the last transaction date column 630 are specific to a contiguous period of time. As shown in merchant-location row 602, the merchant with merchant ID “5678” conducted a first transaction at a first location, “123 Oak Street, San Jose, CA” on a first transaction date of Oct. 1, 2018. The first transaction date marks the beginning of a first contiguous period of time. As also shown in merchant-location row 602, the merchant with merchant ID “5678” conducted a last transaction at the first location, “123 Oak Street, San Jose, CA” on a last transaction date of Oct. 2, 2018. The last transaction date marks the end of the first contiguous period of time.

Further, as shown in merchant-location row 604, according to the illustrative example of FIG. 6, the merchant with merchant ID “5678” conducted a first transaction at a second location on Oct. 3, 2018, and a last transaction at the second location on Oct. 4, 2018, and the period of time between the first transaction date at the second location and the last transaction date at the second location represents a second period of contiguous time. In the specific illustrative example of FIG. 6, as shown at merchant-location row 606, the merchant with merchant ID “5678” then returned to the first location and conducted transactions at the first location for a third contiguous period of time.

It should be appreciated that the construction of mobile merchants table 600 in the specific illustrative example of FIG. 6 may be varied in other embodiments to achieve equal effect. Further, more than one mobile merchants table 600 may be utilized. For instance, there may be a separate table for each mobile merchant. In some embodiments, a mobile merchants table may include only one row for each merchant-location pair, and may include additional columns to represent dates associated with multiple contiguous periods of time. Further, a mobile merchants table may contain fewer columns than those shown in the illustrative example of FIG. 6. A mobile merchants table may also include additional columns for further data, such as, but not limited to, the time of day in which the transactions took place, the types of goods and services provided by the merchant, and/or any other merchant or transaction details that may be desirable for the system and method disclosed herein to track. Of further note, the data contained in the mobile merchants table may comprise data collected from millions of real user transactions, and may also be updated dynamically and/or in real-time, as will be discussed in further detail below.

Returning now to FIG. 5 and FIG. 6 together, once the data associated with the identified mobile merchants is formatted into mobile merchants tables, such as mobile merchants table 600, at 508, process flow proceeds to 510. At 510, one or more merchant movement parameters are defined and utilized to compute how often the location of each mobile merchant should be determined.

Merchant movement parameters may include, but are not limited to, the type of goods and/or services being provided by a particular mobile merchant and/or a total number of transactions conducted by the merchant over a specified period of time. The mobile merchant parameter data may be obtained in a variety of ways. For example, the type of goods and/or services provided by a mobile merchant may already be stored in mobile merchants table 600 and/or may be retrieved from an external third-party database. Additionally, the type of goods and/or services provided by a mobile merchant may be determined by processing the name of the mobile merchant to parse out common identifying words and/or phrases, such as, but not limited to, “Tacos,” “Hot Dogs,” “Coffee,” “Halloween,” “Christmas,” etc. and once obtained, this data may be stored in mobile merchants table 600.

Each value associated with the merchant movement parameters may have an associated frequency rating. For example, a mobile merchant that operates a food truck typically moves to different physical locations throughout any one given day and thus the “food” type of mobile merchant would likely be associated with a high frequency rating. On the other hand, a mobile merchant associated with a popup store that sells seasonal holiday goods, for example, typically remains fixed in one location for several months, and then disappears entirely until the next holiday season, at which point the mobile merchant might reopen their store at a new location. Thus, the “holiday” type of mobile merchant would likely be associated with a low frequency rating. As an additional example, a mobile merchant that does not conduct large numbers of transactions may be associated with a low frequency rating, while a mobile merchant that does conduct large numbers of transactions may be associated with a high frequency rating.

At 510, the frequency ratings associated with the merchant movement parameters are analyzed for each of the mobile merchants, and taken together, they are used to compute a frequency with which to perform location determinations for each of the mobile merchants. The process of computing a frequency with which to perform location determinations for each of the mobile merchants may involve taking an average of the frequency rating values across all of the merchant movement parameters associated with a particular mobile merchant, or it may involve giving higher weight to some merchant movement parameters over others.

Further, instead of utilizing the merchant movement parameters to compute a frequency, a frequency may be dynamically selected by a customer, who may be a user of the method and system disclosed herein. For example, in one illustrative embodiment, a customer of a merchant may indicate, for instance, through a user interface provided by the method and system disclosed herein, that they would like to be notified in real-time about the location of a specified merchant. Absent user preference data, the system and method disclosed herein would compute the ideal frequency of the location determinations for the specified merchant, and might arrive at a decision that location determinations for the specified merchant will be performed at a first frequency, for example, once daily. However, in the advent that user preference data exists, the method and system disclosed herein may choose to ignore existing merchant movement parameter data and instead base its frequency calculations on the preferences provided by the user, thus arriving instead at a decision that location determinations for the specified merchant will be performed at a second frequency, for example, once per minute.

It should be noted that performing location determinations with a high frequency ensures that the data in the mobile merchants table is as current and accurate as possible, while performing location determinations with a low frequency ensures that processing resources and data transfer bandwidth consumed by the process disclosed herein are not wasted unnecessarily.

It should further be noted that, in some embodiments, the method for computing frequencies with which location determinations will be performed, as disclosed herein, may utilize a variety of machine learning algorithms. Additionally, the method for computing frequencies with which location determinations will be performed, as disclosed herein, is accomplished through simultaneous analysis of data contained within billions of global transactional records. Thus, the process disclosed herein is not capable of being performed by the human mind or pen and paper alone.

In one embodiment, once frequencies with which location determinations will be performed are computed for each of the mobile merchants at 510, process flow proceeds to 512. At 512, a new set of transaction records associated with one or more mobile merchants may be obtained, depending on the frequency associated with each of the mobile merchants.

For example, At 512, the frequency for performing location determinations associated with each of the mobile merchants is continually assessed to ascertain whether it is time to perform new location determinations for any of the mobile merchants. Upon ascertaining that new location determinations should be performed for a particular mobile merchant, a new set of transaction records associated with that mobile merchant is obtained, wherein the new set of transaction records comprises records for transactions occurring within the period of time that has elapsed since the last location determinations were performed for that mobile merchant.

Once a new set of transaction records is obtained for a particular mobile merchant at 512, process flow proceeds to 514. At 514, the data in the new set of transaction records is analyzed to determine whether any of the associated transactions include unknown transaction locations, i.e., if any of the associated transactions do not include location data. This determination may be made, for example, by analyzing transaction description strings associated with a transaction record to ascertain whether data identifying a location is present in the transaction description strings.

Upon a determination at 514 that none of the transaction locations associated with a particular mobile merchant are unknown transaction locations, process flow proceeds to 518.

Upon a determination that one or more of the transaction locations are unknown transaction locations at 514, process flow proceeds to 516. At 516, the process 300 of FIG. 3 may be utilized again to regenerate one or more consumption graphs, resulting in newly determined estimated and/or precise point locations associated with the unknown transaction locations.

Once newly estimated and/or precise point locations associated with unknown transaction locations for a particular merchant are determined, process flow proceeds to 518. At 518, the data in one or more mobile merchants tables is updated to reflect the latest locations known to be associated with the particular mobile merchant.

Once a new set of transaction records associated with a mobile merchant has been obtained, the data associated with the transaction records has been analyzed, and estimated and/or precise point location data for one or more of the transactions in the new set of transaction records has been determined, one or more of the mobile merchants tables are updated with the new data. The mobile merchants tables may be updated to overwrite current data in the mobile merchants tables, such that the mobile merchants tables reflect only the most recent data available for the mobile merchants. The mobile merchants tables may instead be updated to append the newly available location data to any existing data in the mobile merchants tables such that records pertaining to the historical whereabouts of the mobile merchants are maintained. For example, it is useful for a mobile merchants table to keep a record of the changes in locations of mobile merchants over a given period of time, to enable greater accuracy in predictions made about the future locations of the mobile merchants, as will be discussed in further detail below.

Once one or more of the mobile merchants tables have been updated at 518, process flow proceeds to 520. At 520, a determination is made as to whether the mobile merchant identification process should be performed again. For example, an operator of the method and system disclosed herein may determine that the merchant identification process should be conducted once a week, once a month, once a quarter, once a year, or at any other frequency, depending on the desires of the operator of the system and method disclosed herein. There are several reasons why it might be desirable to conduct the mobile merchant identification process multiple times. For example, to ensure that newly established mobile merchants are included, or to ensure that mobile merchants who are no longer operational are removed from consideration.

Upon a determination that the merchant identification process should be performed again at 520, process flow returns to 504. Upon a determination that the merchant identification process should not be performed again at 520, process flow returns to 512.

As noted above, once the mobile merchants have been identified at 506, the one or more mobile merchants tables have been generated at 508, and the frequencies associated with the mobile merchants have been computed at 510, the operations of 512, 514, 516, 518 and 520 may occur indefinitely, as governed by the computed frequency associated with each of the mobile merchants.

Once the one or more mobile merchants tables are generated and the process for continually updating the data in the mobile merchants tables has begun, the data in the mobile merchants tables may be accessed at any time by an operator of the method and system disclosed herein, to achieve a wide variety of purposes.

One practical application for the data in the mobile merchants tables is to utilize the mobile merchants data to increase the accuracy of location determinations for merchants that are static, fixed location merchants. For example, once merchants have been identified as mobile merchants, the data in the transaction records associated with the mobile merchants can be removed from the pool of data that is utilized by a method and system for predicting locations of fixed-location merchants.

For example, the process 300 of FIG. 3 for determining locations based on transaction data may be used to arrive at estimated and/or precise point locations for transactions associated with merchants who operate from fixed locations, as well as for transactions associated with mobile merchants. Including data from transaction records associated with merchants who are mobile merchants in the computations for determining locations of transactions associated with merchants operating from fixed locations reduces the accuracy and reliability of the results of merchant location computations for fixed-location merchants. Thus, identifying mobile merchants, tracking their locations, and subsequently removing the associated mobile merchant data from computations related to the location of fixed merchants, increases the accuracy and reliability of the location computations for fixed merchants.

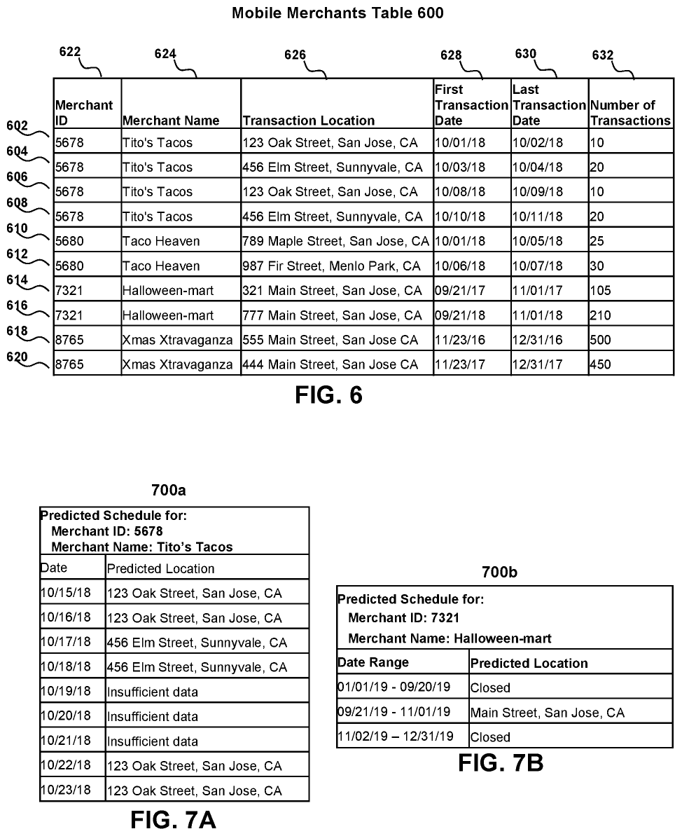

Another practical use for the data in the mobile merchants tables may be to arrive at predictions regarding where a mobile merchant is likely to be located at future dates and times. Referring now to the simplified illustrative examples of FIG. 6, FIG. 7A, and FIG. 7B, the mobile merchants table 600, at merchant-location row 602, contains data indicating that the merchant named “Tito's Tacos” conducted transactions at “123 Oak Street, San Jose, CA” on Monday, Oct. 1, 2018 and on Tuesday Oct. 2, 2018. At merchant-location row 606, the data indicates that “Tito's Tacos” also conducted transactions at “123 Oak Street, San Jose, CA” on Monday, Oct. 8, 2018 and on Tuesday, Oct. 9, 2018. Further, the data in merchant-location rows 604 and 608 indicates that “Tito's Tacos” conducted transactions at “456 Elm Street, Sunnyvale, CA” on Wednesday, Oct. 3, 2018 and Thursday, Oct. 4, 2018, as well as on Wednesday, Oct. 10, 2018 and Thursday, Oct. 11, 2018. Thus, in this simplified example, the system and method disclosed herein is able to predict, based on current and historical location data, that “Tito's Tacos” will be located at “123 Oak Street, San Jose, CA” on future Mondays and Tuesdays and will be located at “456 Elm Street, Sunnyvale, CA” on future Wednesdays and Thursdays. An example predicted schedule 700a for “Tito's Tacos” is shown in FIG. 7A. It should also be noted that the strength of the location predictions will increase significantly with the addition of further corroborating data points.

As a further illustrative example, in FIG. 6 at merchant-location row 614 of the mobile merchants table 600, the data indicates that the mobile merchant named “Halloween-mart” conducted transactions at “321 Main Street, San Jose, CA” from Sep. 21, 2017 to Nov. 1, 2017 in the year 2017, and the data at merchant-location row 616 of the mobile merchants table 600 indicates that “Halloween-mart” conducted transactions at “777 Main Street, San Jose, CA” from Sep. 21, 2018 to Nov. 1, 2018 in the year 2018. Thus the system and method disclosed herein is able to predict that “Halloween-mart” is likely to be conducting transactions in the general vicinity of “Main Street, San Jose, CA” from Sep. 21, 2019 to Nov. 1, 2019 in the year 2019. An example predicted schedule 700b for “Halloween-mart” is shown in FIG. 7B. It should again be noted that that the strength of the location prediction will increase significantly with the addition of further corroborating data points.

Although in the above illustrative examples, a precise address is used to refer to the location of a mobile merchant on a particular date, it should be noted that predictions regarding locations of mobile merchants may also be based on calculations that take into account locations within a radius around one or more precise point locations known to be associated with a given mobile merchant. For example, it may be the case that a mobile merchant does not ever conduct transactions in the exact same location twice. A mobile merchant may conduct transactions in a variety of locations in one zip code on a first day, and variety of locations in a second zip code on a second day. Thus, the system and method disclosed herein may analyze the known and/or historical locations of mobile merchants, calculate the distance between each of the locations, and utilize the results of the calculations to determine one or more predicted location centers, wherein the one or more predicted location centers are used to define an area within a given radius in which a mobile merchant may be operating.

It should be noted that the simplified examples outlined above are for illustrative purposes only, and are not intended to limit the scope of the invention as disclosed herein. It should be recognized that many additional factors may be taken into account while making predictions regarding the locations of mobile merchants. For instance, analysis regarding the type of goods and/or services provided by a mobile merchant may result in a determination that additional factors should be considered while making a location prediction. For example, a mobile merchant operating a food truck might decide to change their location based upon factors such as, but not limited to, the weather forecast, the current season, a school calendar for any educational institutions located nearby, and/or the presence of work sites and constructions zones in the general vicinity in which the mobile merchant typically operates. As a further example, a mobile merchant associated with a store that sells seasonal holiday goods might change their location annually based upon factors such as, but not limited to, the availability and cost of real estate in a particular neighborhood.

Once predictive data regarding mobile merchants has been generated, the predictive data may be stored as part of a mobile merchants table, or may be stored in a separate data structure. The predictive data regarding mobile merchants may also be dynamically generated, for example, in response to a query from a customer.

It should also be noted that the method for predicting locations of mobile merchants disclosed herein may be performed utilizing a variety of machine learning algorithms. Further, the method for predicting locations of mobile merchants disclosed herein is accomplished through simultaneous analysis of data contained within billions of global transactional records. Thus, the process disclosed herein is not capable of being performed by the human mind or pen and paper alone.

Aside from increasing the accuracy of location determinations for merchants that are fixed-location merchants, and arriving at predictions regarding the schedules of the mobile merchants, the data in the mobile merchants tables may further be utilized to identify current and potential customers of mobile merchants. Consequently, another practical use for the data in the mobile merchants tables is to provide customers with data regarding mobile merchants, as well as to provide location-based services that utilize customer and mobile merchant location data.

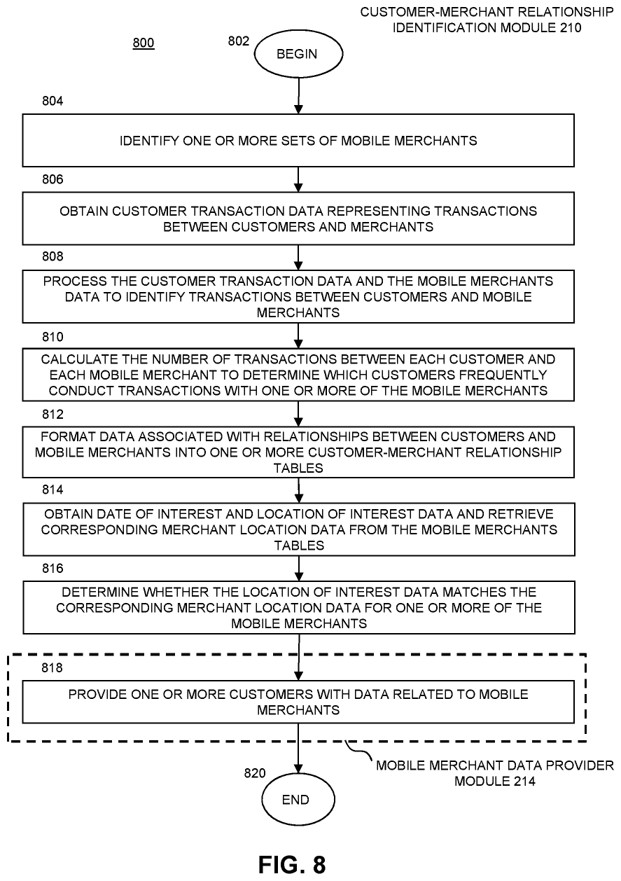

FIG. 8 illustrates a flow diagram of a process 800 for identifying relationships between mobile merchants and customers and providing data associated with mobile merchants to those customers, according to one embodiment. Process 800 begins at 802 and process flow proceeds to 804. At 804, one or more sets of mobile merchants are identified. The one or more sets of mobile merchants are identified by retrieving mobile merchant data from the previously generated mobile merchants tables. The mobile merchant data may include a list of merchant identification names and/or numbers associated with merchants that have been identified as mobile merchants.

Once one or more sets of mobile merchants have been identified at 804, process flow proceeds to 806. At 806, customer transaction data representing transactions between customers and merchants is obtained. As discussed above, a customer may be a user of a data management system, and the customer transaction data may be stored in a database of a data management system. The customer transaction data may also be collected from third party institutions such as, but not limited to, banks, credit card companies, and insurance companies.

Once customer transaction data is obtained at 806, process flow proceeds to 808. At 808, the mobile merchants data and the customer transaction data is processed to identify transactions occurring between customers and mobile merchants.

In order to identify transactions occurring between customers and mobile merchants, a merchant identification segment of each transaction record associated with the customer transaction data is analyzed to determine the identity of the merchant associated with the transaction. The data representing the identity of the merchant associated with the transaction is then compared against the obtained list of mobile merchants to identify transactions that have occurred between a customer and a merchant who has been identified as a mobile merchant.

Once transactions between customers and mobile merchants are identified at 808, process flow proceeds to 810. At 810, the transaction record data is further processed to determine which customers frequently conduct transactions with which mobile merchants.

In various embodiments, in order to identify whether a particular customer frequently conducts transactions with a particular mobile merchant, the number of transactions between the customer and the mobile merchant is calculated by counting the number of transactions associated with the customer that identify that particular mobile merchant.

Further, a threshold number of transactions is selected in order to provide definition for the meaning of the term “frequently.” The threshold number of transactions may be a fixed number, however it is more often the case that the threshold number of transactions is variable and is based on specific merchant details, such as, but not limited to, the type of goods and/or services offered by a merchant. For instance, a particular customer might conduct three transactions with a mobile merchant that sells food over a period of three years, and this number of transactions may not be considered sufficient to determine that the customer frequents that particular food merchant. In contrast, a particular customer might also conduct three transactions with a mobile merchant operating a store that sells seasonal goods over a period of three years, and this number of transactions may be considered sufficient to determine that the customer frequents that particular seasonal merchant.

Further, the dates of the transactions between a particular customer and a particular mobile merchant may be taken into consideration when determining whether a threshold number of transactions has been surpassed. For example, when determining whether the number of transactions between a particular customer and a particular merchant exceeds a certain threshold, it might be desirable for the system and method disclosed herein to place a greater weight on transactions occurring more recently and a lower weight on transactions that occurred less recently. Further still, the customer transaction data being analyzed to determine whether a threshold frequency of transactions has been reached might encompass transactions conducted over the entire history of a particular user's transactional records, or may encompass only transactions occurring during a specified window of time.

Once relationships between customers and merchants have been identified at 810, process flow proceeds to 812. At 812, data associated with the relationships between customers and merchants is formatted and stored in a data structure, such as a table or a database, in order to facilitate further processing.

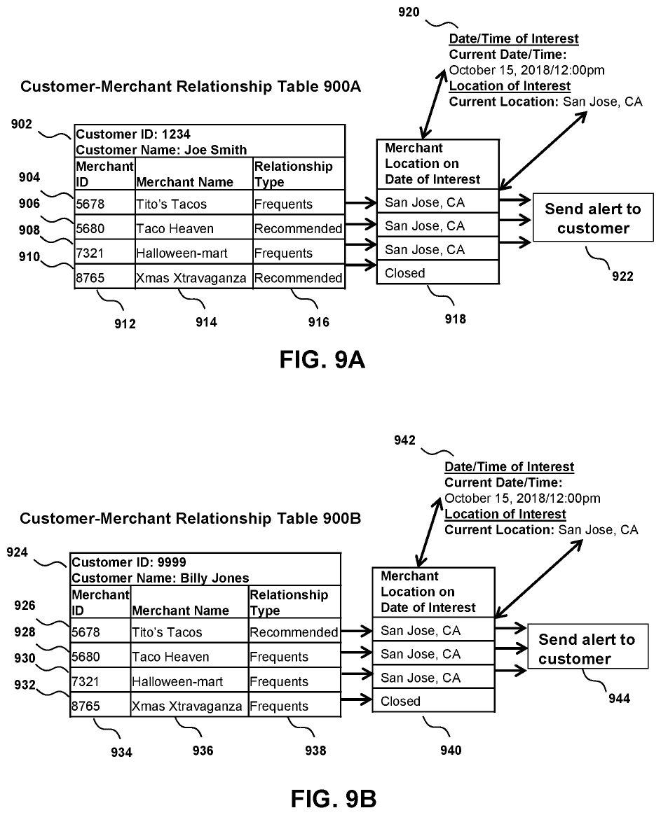

FIG. 9A and FIG. 9B together depict specific illustrative examples of a customer-merchant relationship table 900A and a customer-merchant relationship table 900B, in accordance with one embodiment. In these specific illustrative examples, a separate table is depicted for each user. It should be recognized however that other data structures and configurations may be utilized to achieve the same effect, as discussed in further detail below. The customer-merchant relationship tables 900A and 900B depicted in this specific illustrative example comprise customer identification data 902 and customer identification data 924, as well as one row for each merchant determined to be related to the customer associated with customer identification data 902 and 924. The table rows are depicted here in FIG. 9A as merchant rows 904, 906, 908, and 910, and in FIG. 9B as merchant rows 926, 928, 930, and 932. The customer-merchant relationship tables 900A and 900B further include one column each for various details associated with each merchant in the customer-merchant relationship table. For example, in the illustrative embodiment of FIG. 9A, the customer-merchant relationship table 900A contains a merchant ID column 912, a merchant name column 914, and a relationship type column 916. Likewise, in FIG. 9B, the customer-merchant relationship table 900B contains a merchant ID column 934, a merchant name column 936, and a relationship type column 938.

As noted above, the example customer-merchant relationship tables 900A and 900B, as shown in FIG. 9A and FIG. 9B are for illustrative purposes only, and are not intended to limit the scope of the invention as disclosed herein. It should therefore be recognized that in other embodiments of the present disclosure, a customer-merchant relationship table may include columns containing different pieces of data, and/or more or fewer columns than those described above. For example, a customer-merchant table may also include customer data such as, but not limited to, a customer's age, date of birth, full physical address, email address, as well as additional data related to the merchant's location and relationship with the customer and/or any other pieces of data determined to be relevant for the operation of the embodiments disclosed herein. Further, the one or more customer-merchant relationship tables disclosed herein may contain data for all customers associated with a set of transactions, for all merchants associated with a set of transactions, for one or more sets of customers, for one or more sets of merchants, and/or there may be a separate customer-merchant relationship table generated for each customer and/or each merchant.

Returning now to FIG. 8, once data associated with relationships between customers and mobile merchants is formatted into one or more customer-merchant relationship tables at 812, process flow proceeds to 814. At 814, data representing one or more dates of interest associated with a customer and one or more locations of interest associated with a customer is obtained and corresponding merchant location data is retrieved from the one or more mobile merchants tables.

Typically, the date of interest is the present date, and may also include a time of day, such as the present time of day. However, depending on various factors, such as the preference of a customer and/or the preference of a provider of the method and system disclosed herein, one or more dates of interest may be provided, and may include the present date, a future date, a past date, or any combination thereof. For example, a customer might specify, through a user interface provided by the method and system disclosed herein, that they would like to be alerted about the actual and/or predicted location of a particular mobile merchant, minutes, hours, days, weeks, months, or even years in advance. Further, a customer might wish to view historical location data associated with a mobile merchant. Absent input from a customer, the system and method disclosed herein may automatically determine a default date of interest for a particular customer, for example, the present date and present time of day may be selected as a default date of interest.

Likewise, one or more locations of interest are also determined. Typically, the location of interest is a customer's present location. Data regarding a customer's present location may be obtained through a variety of mechanisms. Such mechanisms may include, but are not limited to, determination of a customer's location based on GPS data retrieved from a customer's computer and/or mobile device, determination of a customer's location based on transactions recently made by the customer, determination of a customer's location based on address data associated with a customer, and/or determination of a customer's location based on data provided directly from the customer, for example, through a user interface provided by the method and system disclosed herein.

Additionally, a location other than the present location of the customer may be selected as a location of interest. For example, a customer might set location preference options, for instance, through a user interface provided by the method and system disclosed herein, requesting to receive alerts regarding the whereabouts of mobile merchants within any locality of a customer's choosing. Customer preference options may enable a customer to select a specific location, a radius around a specific location, and/or the customer may be allowed to specify a list of locations to monitor. For instance, if the customer has acquaintances and/or relatives in other localities, a customer may wish to monitor the activity of mobile merchants in those localities.

Once one or more dates of interest and one or more locations of interest are determined for a particular customer, the mobile merchants associated with the customer are retrieved from the customer-merchant relationship tables. The locations of each of the mobile merchants associated with the customer, on the dates of interest associated with the customer, are then retrieved from the mobile merchants tables for further analysis.

Upon retrieval of mobile merchant locations from the mobile merchant tables at 814, process flow proceeds to 816. At 816, the mobile merchant location data, corresponding to one or more dates of interest associated with a particular customer, which has been retrieved from the mobile merchants tables, is compared to one or more of the locations of interest associated with the particular customer.

Upon a determination that a retrieved location of a mobile merchant associated with a customer matches a location of interest associated with the customer, further action may be taken, such as sending an alert to the customer, as will be described in further detail below. A determination as to whether one location matches another location may be based on equality of two sets of geographical coordinates associated with physical addresses, or equality of two character strings representing the physical address, but will more typically be based on other factors, such as the distance between the two locations, and whether one of the locations is within a pre-defined radius of the other location.

Returning now to FIG. 9A, an illustrative example of the above described process is depicted. As shown in the user identification data 902, customer-merchant relationship table 900A is associated with the customer named “Joe Smith.” As shown in the date and location data 920, the date/time of interest associated with “Joe Smith” is Oct. 15, 2018, 12:00 pm, which may have been the current date/time at the moment the method and system disclosed herein was utilized. Further, the location of interest associated with “Joe Smith” is “San Jose, CA”, which may have been the current location of “Joe Smith” at the moment the method and system disclosed herein was utilized. In this specific illustrative example, the method and system disclosed herein processes the data in the customer-merchant relationship table 900A and determines that the merchant shown in merchant row 904, “Tito's Tacos,” and the merchant shown in merchant row 908, “Halloween-mart,” are both mobile merchants that the user “Joe Smith” frequents.

The method and system disclosed herein then retrieves the date of interest data associated with “Joe Smith” from the customer date and location data 920, which in this illustrative example, is Oct. 15, 2018, 12:00 pm. Estimated and/or precise point locations of the mobile merchants “Tito's Tacos,” and “Halloween-mart” on Oct. 15, 2018, 12:00 pm, are then retrieved from the mobile merchants table. The retrieved location data for the mobile merchants is shown here as merchant location data 918. Next, the location of interest data associated with “Joe Smith” is retrieved from the customer date and location data 920, which in this illustrative example, is “San Jose, CA.” The location of interest is then compared with the merchant location data 918, for the merchants “Tito's Tacos” and “Halloween-mart.”

In the specific illustrative example of FIG. 9A, the system and method disclosed herein compares the location of interest associated with “Joe Smith” and the location of the mobile merchants “Tito's Tacos” and “Halloween-mart” on the associated date of interest, and determines that the locations are a match. “Joe Smith” may then be provided with data, such as alerts 922, regarding the mobile merchants “Tito's Tacos” and “Halloween-mart,” as will be discussed in further detail below.

Returning again to FIG. 8, upon a determination that location of interest data matches the corresponding merchant location data at 816, process flow proceeds to 818. At 818, one or more customers are provided with data related to mobile merchants.

Data related to the mobile merchants may include data regarding the location of mobile merchants, and may be provided to a customer in a variety of formats. Further, the mobile merchant location data may comprise current, predictive, and/or historical data, depending on the one or more dates/times of interest associated with a particular customer. As noted above, a customer may indicate one or more dates/times of interest, for instance, through a user interface provided by the method and system disclosed herein, or a default date/time of interest, such as the current date and current time of day may be used. The system and method disclosed herein may automatically send an alert containing mobile merchant location data to a customer upon a determination that a mobile merchant frequented by the customer has begun conducting transactions at a location in close proximity to one or more locations of interest associated with the customer. In addition to, or instead of, receiving automatic alerts, a customer may also submit a query manually, for instance, through a user interface provided by the method and system disclosed herein, and data regarding the location of one or more mobile merchants may then be retrieved from the mobile merchants tables and provided to the customer upon request. Additionally, a current, future, or historical calendar or schedule may be provided to a customer, containing location data for a particular mobile merchant over any period of time desired by the customer.

In addition to location data, other types of data related to a mobile merchant may be provided to a customer. Such data includes, but is not limited to, ratings and reviews associated with the mobile merchant, a listing of products or services provided by the mobile merchant, prices associated with the products or services provided by the mobile merchant, images related to the mobile merchant and their products or services, a link to a website or page on a social media platform that is associated with the mobile merchant, data regarding expected wait times at the mobile merchant, data relating to offers such as coupons, or data regarding events or sales associated with the mobile merchant.

Mobile merchant data may be provided to a customer by any method of alerting or providing data to a customer currently known to those of skill in the art, or any other means of providing data as may be developed after the time of filing. Such means of alerting or providing data typically include, but are not limited to, sending a Short Media Service (SMS) message, sending a Multimedia Messaging Service (MMS) message, sending a message though an instant messaging service, sending an email, initiating a phone call, and/or alerting a customer online through a social media platform.

Once one or more customers are provided with data related to mobile merchants at 818, process flow proceeds to END 820, and the process 800 for identifying relationships between mobile merchants and customers and providing data associated with mobile merchants to customers is exited to await new data and/or instructions.

In addition to receiving data about merchants that a customer frequents, a customer might also indicate an interest in specific mobile merchants, who may be mobile merchants that the customer has not previously conducted transactions with. A customer may indicate an interest in one or more specific mobile merchants, for instance, through a user interface provided by the method and system disclosed herein. The method and system disclosed herein may then track the customer's preferences, for example, by updating data in a customer-merchant relationship table to reflect a relationship between the customer and one or more mobile merchants. Once a relationship between a customer and a mobile merchant is defined, the customer may be provided with data associated with the mobile merchants of interest. In addition, embodiments of the present disclosure further include a method for identifying potential customers of mobile merchants and providing recommendations regarding mobile merchants to the potential customers.

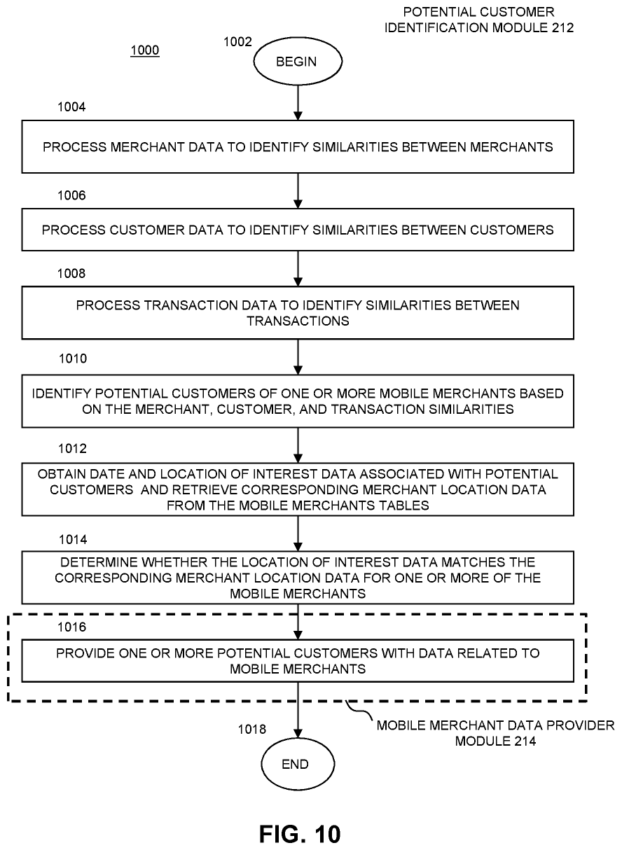

FIG. 10 illustrates a flow diagram of a process 1000 for identifying potential customers of mobile merchants and providing data regarding the mobile merchants to the potential customers, according to one embodiment.

Process 1000 begins at 1002 and process flow proceeds to 1004. At 1004, one or more sets of mobile merchants are identified and data associated with the mobile merchants is obtained and processed to identify similarities between mobile merchants in the one or more sets of mobile merchants. Similarities between mobile merchants may be identified by retrieving and processing the data associated with mobile merchants from the mobile merchants tables. Data associated with the mobile merchants may also be retrieved from a variety of third-party organizations. Processing the mobile merchant data includes analyzing the mobile merchant data based on a set of merchant similarity parameters, and making a determination as to whether a particular mobile merchant is similar to other merchants. For instance, merchant similarity parameters may include, but are not limited to, the locality of a mobile merchant, the types of goods and/or services provided by a mobile merchant, and/or any other merchant data that is known to potentially provide an indication of similarities among merchants. As one example, if two mobile merchants provide the same or similar types of goods and/or services, and both mobile merchants are known to operate in the same or similar geographical area, then the two mobile merchants may be considered, by the method and system disclosed herein, to be similar mobile merchants. Additionally, a mobile merchant might further be compared to non-mobile merchants to determine similarity, since it may be determined that a customer of a particular non-mobile merchant is also a potential customer of a mobile merchant.

Although the definition of similarity between mobile merchants may be pre-defined, similarity may also be determined by a variety of machine learning algorithms, which may be utilized to process billions of merchant transaction records to identify patterns in the merchant and merchant transaction data. As such, the process of identifying similarities among merchants is not a process that can be performed in the human mind or with pen and paper alone.

The data regarding similarity of merchants may be stored in the mobile merchants tables, and/or any other data structure that may be maintained by the method and system disclosed herein for storing data associated with merchants. The data regarding merchant similarity may then be further utilized in determining potential customers of mobile merchants, as will be discussed in further detail below.

Once similarities between merchants are identified at 1004, process flow proceeds to 1006. At 1006, one or more sets of customers of mobile merchants are identified and data associated with the customers is obtained and processed to identify similarities between customers in the one or more sets of customers.

Similarities between customers are identified by processing data associated with the customers, which may be obtained by the method and system disclosed herein in a variety of ways. For example, customer data may be obtained from user records associated with users of a data management system. Processing the customer data includes analyzing the customer data based on a set of customer similarity parameters, and making a determination as to whether a particular customer is similar to other customers. For instance, customer similarity parameters may include, but are not limited to, a customer's geographical location, age, race, gender, marital status, financial status, educational status, career status, number and type of dependents, and/or any other customer data that is known to potentially provide an indication of similarities among customers. As one illustrative example, if two customers live in the same geographical area, are both the same age and gender, are unmarried, and are in college, then the two customers may be considered, by the method and system disclosed herein, to be similar customers.

Although the definition of similarity between customers may be pre-defined, similarity may also be determined by a variety of machine learning algorithms, which may be utilized to process billions of customer records to identify patterns in the customer data. As such, the process of identifying similarities among customers is not a process that can be performed in the human mind or with pen and paper alone.

The data regarding similarity of customers may be stored in one or more customer-merchant relationship tables, and/or any data structure that may be maintained by the method and system disclosed herein for storing data associated with customers. The data regarding customer similarity may then be further utilized in determining potential customers of mobile merchants, as will be discussed in further detail below.

Once similarities between customers are identified at 1006, process flow proceeds to 1008. At 1008, data associated with transactions between customers and merchants is obtained and processed to identify similarities between the transactions.

Similarities between transactions are identified by processing data associated with the transactions, which may be obtained by the method and system disclosed herein in a variety of ways. For example, transaction data may be obtained from user transaction data associated with users of a data management system, which may be stored in a database of the data management system. Processing the transaction data includes analyzing the transaction data based on a set of transaction similarity parameters, and making a determination as to whether a particular transaction is similar to other transactions. For instance, transaction similarity parameters may include, but are not limited to, the location of the transaction, time of the transaction, date of the transaction, merchant name associated with the transaction, the type of goods and/or services provided by the merchant associated with the transaction, and/or any other transaction data that is known to potentially provide an indication of similarities among transactions. As one example, if two transactions associated with two different customers were conducted in the same geographical area, around the same date, and were both associated with merchants bearing similar names, then the two transactions may be considered, by the method and system disclosed herein, to be similar transactions.

Although the definition of similarity between transactions may be pre-defined, similarity may also be determined by a variety of machine learning algorithms, which may be utilized to process billions of transaction records to identify patterns in the transaction data. As such, the process of identifying similarities among transactions is not a process that can be performed in the human mind or with pen and paper alone.

The data regarding similarity of transactions may be stored in any data structure that may be maintained by the method and system disclosed herein for storing data associated with transactions. The data regarding transaction similarity may then be further utilized in determining potential customers of mobile merchants, as will be discussed in further detail below.

Once similarities between customer transactions are identified at 1008, process flow proceeds to 1010. At 1010, the merchant, customer, and transaction similarity data is processed and analyzed to identify potential customers of mobile merchants.

Processing the merchant, customer, and transaction similarity data comprises analyzing the merchant, customer, and transaction similarity data both separately, and as a whole. For example, if a first mobile merchant associated with a customer is found to be similar to a second mobile merchant, then the customer may be identified as a potential customer of the second mobile merchant. Likewise, if a first customer is found to be similar to a second customer, then the first customer may be identified as a potential customer of the mobile merchants associated with the second customer, and vice-versa. Further, if transactions associated with a first customer and transactions associated with a second customer are found to be similar, then the first customer may be identified as a potential customer of the mobile merchants associated with the second customer, and vice-versa.

The identification of potential customers may further comprise the analysis of any combination of the above factors to arrive at a percentage indicating a likelihood that a particular customer will be interested in becoming a customer of particular merchant. Further, a potential customer may be defined as a customer who has a percentage of likelihood, over a defined threshold, of becoming a customer of a particular mobile merchant. The threshold may be defined dynamically by the method and system disclosed herein. For example, the threshold may be defined at 70%, and processing of the merchant, customer, and transaction similarity data may result in generation of a percentage score associated with a customer-merchant pair of 75%, in which case, the particular customer would be defined as a potential customer of the particular mobile merchant. It should be noted that the identification of potential customers is not limited to the illustrative examples provided above. For example, in some embodiments, one or more potential customers may be determined by a variety of machine learning algorithms.

Once one or more potential customers are identified by the method and system disclosed herein, the customer-merchant relationship tables may be updated to add the newly identified relationships between customers and mobile merchants.

Returning now to FIG. 6 and FIG. 9A, together, an illustrative example of the method and system as disclosed herein is depicted. In the illustrative example of FIG. 6, in mobile merchants table 600, at row 602, “Tito's Tacos,” has been identified as a mobile merchant who conducted transactions at “123 Oak Street, San Jose, CA” in October of 2018, and in mobile merchants table 600, at row 610, “Taco Heaven,” has been identified as a mobile merchant who conducted transactions at “789 Maple Street, San Jose, CA” in October of 2018. Thus, in various embodiments of the system and method disclosed herein, “Tito's Tacos” and “Taco Heaven” are identified as being similar or related merchants, due to the fact that they both sell the same type of product and are both known to operate in the vicinity of San Jose, Calif.

Thus, in this specific illustrative embodiment, the system and method disclosed herein may update customer-merchant relationship table 900A to reflect a relationship between “Joe Smith,” a customer of “Tito's Tacos” who has been associated with the location of interest, “San Jose, CA,” and “Taco Heaven,” which is a mobile merchant known to operate in the vicinity of Joe Smith's location of interest. This update is reflected in the illustrative example of FIG. 9A, at merchant row 906 of customer-merchant relationship table 900A. Likewise, based on the above example, the customer of customer-merchant relationship table 900B, “Billy Jones,” may be identified as a potential customer of the merchant named “Tito's Tacos,” and, provided that the corresponding date and location data 942 matches the merchant location data 940, the customer “Billy Jones” may be sent one or more alerts 944 regarding this mobile merchant.

As a further example, as shown in FIG. 9A and 9B together, it can be seen in merchant rows 908 and 930 that a first customer, “Joe Smith,” frequents a merchant named “Halloween-mart,” and a second customer, “Billy Jones,” also frequents the merchant named “Halloween-mart.” Further, “Billy Jones” is known to frequent a merchant named “Xmas Xtravaganza.” Based on this simplified example, embodiments of the system and method disclosed herein may determine that “Joe Smith” is a potential customer of “Xmas Xtravaganza.” Thus, the system and method disclosed herein may update the customer-merchant relationship table 900A to add a relationship between customer “Joe Smith,” and the mobile merchant, “Xmas Xtravaganza.” This update is reflected in the illustrative example of FIG. 9A, at row 910 of customer-merchant relationship table 900A.

It should be noted that in FIG. 9A and FIG. 9B, the particular textual strings used to identify a relationship between a customer and a mobile merchant, which are shown in the relationship type columns 916 and 938 of customer-merchant relationship tables 900A and 900B, as “Frequents” or “Recommended,” are provided for illustrative purposes only. Any combination of textual strings, numerical values, icons and/or other indicators may be used to represent a relationship between a customer and a mobile merchant. Further, the relationship identifiers used to indicate the type of relationship that exists between a customer and a mobile merchant may be updated or changed as new data is received from the customer transactional records. For instance, if a customer eventually becomes a frequent customer of a mobile merchant that was initially a recommended, but not frequented mobile merchant, the relationship type column is updated for that customer-merchant pair. Additionally, a customer might indicate, for example, through a user interface provided as part of the method and system disclosed herein, that the customer is not interested in receiving further alerts or notifications about a particular mobile merchant, and so the relationship type column would be updated to reflect the change in relationship status.

Returning now to FIG. 10, once potential customers are identified at 1010, process flow proceeds to 1012. At 1012, data representing one or more dates of interest associated with a potential customer and one or more locations of interest associated with a potential customer is obtained and corresponding merchant location data is retrieved from the one or more mobile merchants tables. The process of obtaining dates and locations of interest associated with a potential customer is essentially identical to the process described above at 814.

Once dates and locations of interest associated with a potential customer are obtained at 1012, process flow proceeds to 1014. At 1014, the mobile merchant location data, corresponding to one or more dates of interest associated with a particular potential customer, which has been retrieved from the mobile merchants tables, is compared to one or more of the locations of interest associated with the particular potential customer to determine whether the merchant location and the location of interest match. The process of determining whether the merchant location and the potential customer's location of interest match is essentially identical to the process described above at 816.

Upon a determination that merchant location data and location of interest data matches at 1014, process flow proceeds to 1016. At 1016, one or more potential customers are provided with data related to mobile merchants. The process of providing potential customers with data related to mobile merchants is essentially identical to the process described above at 818.

Once one or more potential customers are provided with data related to mobile merchants at 1016, process flow proceeds to 1018, and the process 1000 for identifying potential customers of mobile merchants and providing data regarding the mobile merchants to the potential customers is exited to await new data and/or instructions.

Using the disclosed embodiments, a method and system for identifying, tracking, and predicting the location of mobile merchants is provided. The disclosed embodiments provide a technical solution to the technical problem of identifying, tracking, and predicting the location of mobile merchants by utilizing location resolution and spatial analysis techniques to process, analyze, and enhance data obtained from customer transactions.

It should be noted that the foregoing examples are given for illustrative purposes only, and are not intended to limit the scope of the invention as disclosed herein. Further, the process of identifying potential customers may be performed by a variety of machine learning algorithms, which may process billions of merchant, customer, and customer transaction records to identify patterns in the merchant, customer, and customer transaction data. As such, the process of identifying potential customers based on shared characteristics among merchants, customers, and customer transactions is not a process that can be performed in the human mind or with pen and paper alone.

Further, by utilizing pattern recognition techniques in conjunction with spatial analytics based on customer transactional data, the method and system herein is able to provide customers with unique data, which was previously either difficult or impossible for the customers to obtain. As such, the method and system disclosed herein is not an abstract idea, and also serves to integrate the ideas disclosed herein into practical applications of those ideas.

In the embodiments disclosed herein, mobile merchants are identified and the various locations associated with the identified mobile merchants are ascertained and predicted through a method and system utilizing location resolution, which relies on spatial analysis of billions of customer transactional records. Thus, the technical solution disclosed herein cannot be implemented solely by mental steps or pen and paper, is not an abstract idea, and is, in fact, directed to providing technical solutions to long-standing technical problems associated with identifying, tracking, and predicting the location of mobile merchants.

Additionally, the disclosed method and system for identifying, tracking, and predicting the location of mobile merchants is accomplished through a specific location resolution process comprising the aggregation and detailed analysis of customer account and transaction data, and as such, does not encompass, embody, or preclude other forms of innovation in the area of merchant location identification. Further, the disclosed embodiments of systems and methods for identifying, tracking, and predicting the location of mobile merchants are not abstract ideas for at least several reasons.

First, effectively and efficiently identifying, tracking, and predicting the location of mobile merchants is not an abstract idea because it is not merely an idea in and of itself. For example, the process cannot be performed mentally or using pen and paper, as it is not possible for the human mind to identify, process, and analyze all possible combinations of locations, times and dates related to billions of transactional records from millions of customers and/or users of a data management system, even with pen and paper to assist the human mind and even with unlimited time.

Second, effectively and efficiently identifying, tracking, and predicting the location of mobile merchants is not a fundamental economic practice (e.g., is not merely creating a contractual relationship, hedging, mitigating a settlement risk, etc.).

Third, effectively and efficiently identifying, tracking, and predicting the location of mobile merchants is not merely a method of organizing human activity (e.g., managing a game of bingo). Rather, in the disclosed embodiments, effectively and efficiently identifying, tracking, and predicting the location of mobile merchants provides a tool that significantly improves the field of data management. By utilizing pattern recognition techniques in conjunction with spatial analytics based on customer transactional data, the method and system herein is able to provide customers with unique data, which was previously either difficult or impossible for customers to obtain. As such, the method and system disclosed herein is not an abstract idea, and also serves to integrate the ideas disclosed herein into practical applications of those ideas.

Fourth, although mathematics may be used to implement the embodiments disclosed herein, the systems and methods disclosed and claimed herein are not abstract ideas because the disclosed systems and methods are not simply a mathematical relationship/formula.

In addition, effectively and efficiently identifying, tracking, and predicting the location of mobile merchants results in reduced use of processor cycles, memory, and power consumption. Therefore, hardware systems implementing or providing the disclosed embodiments operate more efficiently and are transformed into more accurate and effective devices and system. Consequently, the disclosed embodiments allow both human and non-human resources to be utilized more efficiently.

It should also be noted that the language used in the specification has been principally selected for readability, clarity, and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the figures are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method comprising:
obtaining one or more transactions between merchants and customers;
determining, based on analysis of the transactions, one or more merchants associated with the transactions;
determining, based on analysis of the transactions, one or more locations associated with the transactions, wherein the one or more locations are determined by:
analyzing a plurality of transaction description strings associated with the transactions to generate one or more branch identification patterns for the one or more merchants;
creating one or more extended transaction records by appending branch identifiers to transaction records when a branch identification pattern identifies a branch identifier in a transaction description string and discarding transaction records when none of the branch identification patterns identifies a branch identifier in a transaction description string;
creating one or more consumption graphs based on the extended transaction records;
determining estimated locations associated with transactions based on the consumption graphs; and
determining precise point locations, based on the estimated locations;
identifying, based on the one or more merchants and the one or more locations, one or more mobile merchants;
determining, based on transactions associated with the one or more mobile merchants, location schedules associated with the one or more mobile merchants; and
based on the location schedules, providing the location of the one or more mobile merchants to current or potential customers of the one or more mobile merchants.

2. The method of claim 1 wherein determining, based on analysis of the transactions, one or more merchants associated with the transactions is performed by analyzing data stored in a merchant identification segment of the transaction data, the merchant identification segment including one or more of:
a merchant name;
a merchant identification number;
a branch identification string; and
a branch identification number.

3. The method of claim 1, wherein creating one or more consumption graphs based on the extended transaction records includes:
defining one or more location nodes based on the extended transaction record data, wherein the one or more location nodes are defined by a merchant identifier and a branch identifier;
determining a total number of customers associated with each of the one or more location nodes; and
defining an edge between every unique pair of location nodes, wherein the edge represents a percentage of the total number of customers that have transactions associated with a first location node and a second location node in the unique pair of nodes.

4. The method of claim 1, wherein determining estimated locations associated with transactions based on the consumption graphs includes:
defining one or more nodes as known location nodes, wherein known location nodes are defined as nodes representing transactions associated with merchants at locations that are known;
defining one node as an unknown location node, wherein the unknown location node is defined as a node representing a transaction associated with a merchant at a location that has not yet been determined;
identifying a plurality of edges connecting to the unknown location node, wherein each edge of the plurality of edges also connects to a known location node, and further wherein each edge has an associated weight; and
estimating the location of the unknown location node based on the weight associated with each edge in the plurality of edges.

5. The method of claim 4 wherein the weight of each edge is defined by:
calculating the total number of unique customers having transactions associated with either the unknown location node or the known location node;
calculating the number of unique customers having transactions associated with both the unknown location node and the known location node; and
defining the weight of each edge based on the percentage of total unique customers having transactions associated with both the unknown location node the known location node.

6. The method of claim 1 wherein identifying, based on the one or more merchants and the one or more locations, one or more mobile merchants includes:
determining a first transaction location associated with a merchant during a first period of time;
determining one or more additional transaction locations associated with the merchant during one or more additional periods of time;
identifying a merchant as a potential mobile merchant when the first transaction location during the first period of time is different than one or more additional transaction locations during one or more additional periods of time;
defining a threshold number of transactions associated with a potential mobile merchant occurring at different locations, wherein the threshold number of transactions is utilized to determine that a potential mobile merchant should be identified as a mobile merchant; and
defining a threshold number of different locations associated with a potential mobile merchant, wherein the threshold number of locations is utilized to determine that a potential mobile merchant should be identified as a mobile merchant.

7. The method of claim 1 wherein determining, based on transactions associated with the one or more mobile merchants, location schedules associated with the one or more mobile merchants includes:
formatting mobile merchant data and known mobile merchant transaction location data into one or more mobile merchants tables;
computing a frequency with which to perform location determinations to identify unknown transaction locations associated with one or more mobile merchants;
performing, at the computed frequency, location determinations to identify unknown transaction locations associated with the one or more mobile merchants during one or more periods of time;
updating the mobile merchants tables, at the computed frequency, with the results of the transaction location determinations, such that the mobile merchants tables contain known mobile merchant location data; and
predicting locations of the one or more mobile merchants during one or more periods of time, based on the data in the mobile merchants tables.

8. The method of claim 7 wherein computing a frequency with which to perform location determinations to identify unknown transaction locations associated with one or more mobile merchants includes:
defining one or more merchant movement parameters;
assigning a frequency rating to each of the merchant movement parameters; and
for each of the mobile merchants, utilizing the frequency ratings to compute a frequency with which to perform location determinations.

9. The method of claim 8 wherein the one or more merchant movement parameters include:
the type of goods or services provided by a merchant; and
the number of transactions conducted by a merchant over a specified period of time.

10. A computing system implemented method comprising:
identifying a set of mobile merchants;
identifying customers that frequently conduct transactions with one or more of the mobile merchants in the set of mobile merchants;
determining one or more time periods of interest associated with one or more of the customers;
determining one or more locations of interest associated with one or more of the customers; and
providing one or more of the customers information associated with one or more of the mobile merchants in the set of mobile merchants based on the determined periods of interest and locations of interest for one or more of the customers.

11. The method of claim 10 wherein identifying customers that frequently conduct transactions with one or more of the mobile merchants further comprises:
obtaining one or more transactions between customers and merchants;
determining whether one or more merchants associated with the transactions have been identified as mobile merchants;
calculating the number of transactions between one or more customers and one or more mobile merchants; and
determining whether a customer frequently conducts transactions with a mobile merchant by setting a threshold number of transactions for the mobile merchant such that a number of transactions between the customer and the mobile merchant that is over the threshold number results in a determination that the customer frequently conducts transactions with the mobile merchant.

12. The method of claim 11 wherein the threshold number of transactions for a mobile merchant is determined based on the type of goods or services provided by the mobile merchant.

13. The method of claim 10 wherein determining one or more time periods of interest associated with one or more of the customers comprises defining a customer's time period of interest as the current date and time.

14. The method of claim 10 wherein determining one or more locations of interest associated with one or more of the customers includes:
defining a customer's location of interest as the current location of the customer; and
determining the current location of the customer.

15. The method of claim 14 wherein determining the current location of the customer includes one or more of:
identifying locations associated with customer transactions, wherein the customer transactions occur on or about the current date and time; and
obtaining GPS data identifying a customer's current location.

16. The method of claim 10 wherein providing a customer information associated with one or more mobile merchants includes one or more of:
alerting the customer when one or more mobile merchants are in a location of interest associated with the customer at a time period of interest associated with the customer;
providing the customer with predictions regarding one or more future locations of one or more mobile merchants;
providing the customer with a schedule representing locations and time periods associated with one or more mobile merchants; and
providing the customer with non-location information associated with one or more mobile merchants, wherein the non-location information associated with a mobile merchant includes one or more of:
a rating associated with the mobile merchant;
one or more reviews associated with the mobile merchant;
a listing of products or services provided by the mobile merchant;
a listing of prices associated with the products or services provided by the mobile merchant;
one or more images associated with the mobile merchant;
a link to a website associated with the mobile merchant;
a link to a page on a social media platform associated with the mobile merchant;
information regarding expected wait times at the mobile merchant;
information regarding sales associated with the mobile merchant; and
information regarding coupons associated with the mobile merchant.

17. A computing system implemented method comprising:
identifying a set of mobile merchants;
identifying a set of customers of the mobile merchants in the set of mobile merchants;
identifying, based on a set of merchant similarity parameters, two or more similar mobile merchants in the set of mobile merchants;
identifying, based on a set of customer similarity parameters, two or more similar customers in the set of customers of the mobile merchants;
identifying, based on the two or more similar mobile merchants or the two or more similar customers, a potential customer of a mobile merchant in the set of mobile merchants;
determining one or more time periods of interest associated with the potential customer of the mobile merchant;
determining one or more locations of interest associated with the potential customer of the mobile merchant; and
providing the potential customer of the mobile merchant with information associated with the mobile merchant.

18. The method of claim 17 wherein identifying, based on the two or more similar mobile merchants or the two or more similar customers, a potential customer of a mobile merchant in the set of mobile merchants includes one or more of:
identifying a first similar mobile merchant of the two or more similar mobile merchants;
identifying a second similar mobile merchant of the two or more similar mobile merchants;
identifying a customer of the first similar mobile merchant as a potential customer of the second similar mobile merchant;
identifying a first similar customer of the two or more similar customers;
identifying a second similar customer of the two or more similar customers; and
identifying the first similar customer as a potential customer of a mobile merchant associated with the second similar customer.

19. The method of claim 17 wherein the time period of interest associated with the potential customer of the mobile merchant is the current date and the current time; and
the location of interest associated with the potential customer of the mobile merchant is the current location of the potential customer.

20. The method of claim 17 wherein providing the potential customer of the mobile merchant with information associated with the mobile merchant includes one or more of:
alerting the potential customer of the mobile merchant when the mobile merchant is in a location of interest associated with the potential customer of the mobile merchant at a time period of interest associated with the potential customer of the mobile merchant;
providing the potential customer of the mobile merchant with predictions regarding one or more future locations of the mobile merchant;
providing the potential customer of the mobile merchant with a schedule representing locations and time periods associated with the mobile merchant; and
providing the potential customer of the mobile merchant with non-location information associated with the mobile merchant, wherein the non-location information associated with the mobile merchant includes one or more of:
a rating associated with the mobile merchant;
one or more reviews associated with the mobile merchant;
a listing of products or services provided by the mobile merchant;
a listing of prices associated with the products or services provided by the mobile merchant;
one or more images associated with the mobile merchant;
a link to a website associated with the mobile merchant;
a link to a page on a social media platform associated with the mobile merchant;
information regarding expected wait times at the mobile merchant;
information regarding sales associated with the mobile merchant; and
information regarding coupons associated with the mobile merchant.
